(19) United States
(12) Patent Application Publication
(10) Pub. No.: US 2026/0225861 A1
(43) Pub. Date: Aug. 6, 2026

(54) CRANE SWING CONTROL DEVICE, CRANE EQUIPPED THEREWITH, AND CRANE SWING METHOD

(71) Applicants: KABUSHIKI KAISHA KOBE SEIKO SHO (Kobe Steel, Ltd.), Kobe-shi (JP); KOBELCO CONSTRUCTION MACHINERY CO., LTD., Hiroshima-shi (JP)

(72) Inventors: Naoki SUGANO, Kobe-shi (JP); Koichiro SHINNO, Kobe-shi (JP); Yasuo ICHIKAWA, Hyogo (JP); Hitoshi KUROTSU, Hyogo (JP)

(73) Assignees: KABUSHIKI KAISHA KOBE SEIKO SHO (Kobe Steel, Ltd.), Kobe-shi (JP); KOBELCO CONSTRUCTION MACHINERY CO., LTD., Hiroshima-shi (JP)

(21) Appl. No.: 19/154,873

(22) PCT Filed: Feb. 13, 2024
(86) PCT No.: PCT/JP2024/004736

§ 371 Date: Aug. 8, 2025

(30) Foreign Application Priority Data
Feb. 15, 2023 (JP) 2023-021691

(51) Int. Cl. B66C 13/20; B66C 13/16; B66C 13/48; B66C 23/86; B66C 23/94

(52) U.S. Cl. CPC B66C 13/20; B66C 13/16; B66C 13/48; B66C 23/86; B66C 23/94

(57) ABSTRACT

A slewing control unit of a control unit receives a slewing command signal output from an operation unit and controls a slewing drive unit such that an upper slewing body slews with respect to a lower travelling body in response to the slewing command signal. Further, the slewing control unit controls the slewing drive unit so that the slewing angular velocity of the upper slewing body does not exceed a maximum slewing angular velocity set by an angular velocity setting unit, and also outputs an auxiliary command signal for reducing the slewing angular velocity of the upper slewing body when the actual slewing angular velocity of the upper slewing body approaches the maximum slewing angular velocity or exceeds the maximum slewing angular velocity.

### TECHNICAL FIELD

The present invention relates to a crane slewing control device, a cranc including the same, and a slewing method for a crane.

### BACKGROUND ART

Conventionally, as a mobile crane, a crane that includes a lower travelling body, an upper slewing body, and an attachment such as a boom and a jib is known. The attachment is attached to the front of the upper slewing body so as to be hoisted and lowered. When a hoist cargo is connected to a hoist cargo rope hanging down from the distal end of the attachment, the work of hoisting the hoist cargo becomes possible. In such a crane, the slewing operation of the upper slewing body may be performed with the hoist cargo being hoisted.

Patent Literature 1 discloses a technique for setting a maximum slewing angular velocity allowed in a slewing operation of an upper slewing body based on attachment information (a length of the attachment or the like) and slewing information of a crane (hoist cargo load, working radius) in order to suppress damage of the attachment.

### CITATION LIST

### Patent Literature

Patent Literature 1: JP 2022-115073 A

The technique described in Patent Literature 1 has a problem that it is difficult to sufficiently control the slewing speed of the upper slewing body depending on the characteristics of the hydraulic circuit mounted on the crane and the work conditions at the work site.

Specifically, in the above technique, in order to suppress the slewing angular velocity of the upper slewing body to be equal to or less than the maximum slewing angular velocity, the tilt of the hydraulic pump or the flow rate control device (operation lever amount) is controlled. However, in the hydraulic pump, due to its characteristics, the ratio between the maximum capacity and the minimum capacity is determined in advance, and the ratio between the maximum angular velocity and the minimum angular velocity of the upper slewing body is also determined by the ratio of the capacity. For this reason, in order to satisfy the maximum angular velocity required for the slewing angular velocity from the specification of the crane, the minimum angular velocity is also inevitably determined. Therefore, the slewing angular velocity cannot be controlled to a magnitude equal to or less than the minimum angular velocity, and the angular velocity of the upper slewing body cannot be controlled to be equal to or less than the maximum slewing angular velocity set in terms of control in some cases.

When the slewing angular velocity is controlled by the flow rate control device, the slewing angular velocity is controlled by adjusting the flow rate of the fluid released from the hydraulic pump to the tank. In this case, when the flow rate released from the hydraulic pump to the tank increases, the pressure of the hydraulic oil supplied to the slewing motor decreases, so that the slewing torque may decrease, and the upper slewing body may not move due to wind at the work site or the like. For this reason, in practice, the flow rate to be released from the hydraulic pump to the tank cannot be increased, and there is a limit to the minimum angular velocity that can be realized even in this case. Therefore, there is a case where the angular velocity of the upper slewing body cannot be controlled to be equal to or less than the set maximum slewing angular velocity depending on conditions.

Further, when the wind acts in the tailwind direction with respect to the slewing direction of the attachment, there is a problem that the slewing angular velocity is increased and exceeds a set maximum slewing angular velocity. Similarly, even when the weight of the attachment acts in the slewing direction due to the ground inclination at the work site, there is a problem that the slewing angular velocity is increased and exceeds the set maximum slewing speed.

### SUMMARY OF INVENTION

An object of the present invention is to provide a crane slewing control device capable of stably suppressing damage and breakage of an attachment by application of a large transverse load to the attachment by a slewing operation of an upper slewing body, a crane including the crane slewing control device, and a slewing method for a crane.

A crane slewing control device according to one aspect of the present invention is a crane slewing control device used for a crane including: a lower body; an upper slewing body supported by the lower body to be slewable with respect to the lower body; an operation unit that receives an operation to slew the upper slewing body and outputs a slewing command signal according to a magnitude of the operation; a slewing drive unit capable of slewing the upper slewing body with respect to the lower body; an attachment that includes a proximal end pivotably supported by the upper slewing body in a hoisting direction and a distal end opposite the proximal end; and a hoist cargo rope that hangs down from the distal end of the attachment and is connected to a hoist cargo. The slewing control device includes: a load information acquisition unit that acquires load information, the load information being information for setting a maximum slewing angular velocity that is a maximum value of a slewing angular velocity based on a transverse load which is a load along a tangential direction in a slewing operation of the upper slewing body and which acts on the attachment due to a slewing angular velocity of the upper slewing body; an angular velocity setting unit that sets the maximum slewing angular velocity allowed in the slewing operation of the upper slewing body based on the load information acquired by the load information acquisition unit; and a slewing control unit that receives the slewing command signal output from the operation unit, controls the slewing drive unit such that the upper slewing body slews with respect to the lower body in response to the slewing command signal, controls the slewing drive unit so that the slewing angular velocity of the upper slewing body does not exceed the maximum slewing angular velocity set by the angular velocity setting unit, and outputs an auxiliary command signal for reducing the slewing angular velocity of the upper slewing body when an actual slewing angular velocity of the upper slewing body approaches the maximum slewing angular velocity or exceeds the maximum slewing angular velocity.

A crane according to another aspect of the present invention includes: a lower body; an upper slewing body supported by the lower body to be slewable with respect to the lower body; an operation unit that receives an operation to slew the upper slewing body and outputs a slewing command signal according to a magnitude of the operation; a slewing drive unit capable of slewing the upper slewing body with respect to the lower body; an attachment that includes a proximal end pivotably supported by the upper slewing body in a hoisting direction and a distal end opposite the proximal end; a hoist cargo rope that hangs down from the distal end of the attachment and is connected to a hoist cargo; and the crane slewing control device which controls the slewing drive unit so that a slewing angular velocity of the upper slewing body does not exceed a maximum slewing angular velocity.

A slewing method for a crane according to another aspect of the present invention is a slewing method for a crane including: a lower body; an upper slewing body supported by the lower body to be slewable with respect to the lower body; an operation unit that receives an operation to slew the upper slewing body and outputs a slewing command signal according to a magnitude of the operation; a slewing drive unit capable of slewing the upper slewing body with respect to the lower body; an attachment that includes a proximal end pivotably supported by the upper slewing body in a hoisting direction and a distal end opposite the proximal end; and a hoist cargo rope that hangs down from the distal end of the attachment and is connected to a hoist cargo. The slewing method includes: acquiring load information which is information for setting a maximum slewing angular velocity that is a maximum value of a slewing angular velocity based on a transverse load which is a load along a tangential direction in a slewing operation of the upper slewing body and which acts on the attachment due to the slewing angular velocity of the upper slewing body; setting the maximum slewing angular velocity allowed in the slewing operation of the upper slewing body based on the acquired load information; controlling the slewing drive unit such that the upper slewing body slews with respect to the lower body in response to the slewing command signal output from the operation unit, controlling the slewing drive unit such that the slewing angular velocity of the upper slewing body does not exceed the maximum slewing angular velocity, and outputting an auxiliary command signal for reducing the slewing angular velocity of the upper slewing body when an actual slewing angular velocity of the upper slewing body approaches the maximum slewing angular velocity or exceeds the maximum slewing angular velocity.

### BRIEF DESCRIPTION OF DRAWINGS

FIG. 1 is a side view of a crane including a slewing control device according to a first embodiment of the present invention.

FIG. 2 is a hydraulic circuit diagram of a slewing drive unit of the crane according to the first embodiment of the present invention.

FIG. 3 is a block diagram of the slewing control device according to the first embodiment of the present invention.

FIG. 4 is a graph showing the change of an operation amount received by an operation lever when the crane performs a slewing operation.

FIG. 5 is a graph showing the change of a slewing angular velocity of an upper slewing body when the crane performs the slewing operation.

FIG. 6 is a graph showing the change of a cargo swing amount of a hoist cargo when the crane performs the slewing operation.

FIG. 7 is a graph showing the change of a swing amount of an attachment tip when the crane performs the slewing operation.

FIG. 8 is a schematic view for explaining a working radius of the crane according to the first embodiment of the present invention.

FIG. 9 is a graph of a slewing angular velocity limit value set in the slewing control device according to the first embodiment of the present invention.

FIG. 10 is a graph showing the relationship between the slewing angular velocity limit value set in the slewing control device and a pump tilt according to the first embodiment of the present invention.

FIG. 11 is a flowchart of the slewing control of the crane performed by the slewing control device according to the first embodiment of the present invention.

FIG. 12 is a graph for explaining a method of calculating an actual slewing angular velocity in the slewing control device according to the first embodiment of the present invention.

FIG. 13 is a graph showing a suppression effect of a slewing angular velocity in the slewing control executed by the slewing control device according to the first embodiment of the present invention.

FIG. 14 is a graph showing time transition of a lever operation amount and an actual slewing angular velocity in a slewing control executed by a slewing control device according to a modified embodiment of the present invention.

FIG. 15 is a graph showing time transition of a lever operation amount and an actual slewing angular velocity in a slewing control executed by a slewing control device according to a modified embodiment of the present invention.

FIG. 16 is a flowchart of the slewing control of the crane performed by the slewing control device according to a second embodiment of the present invention.

FIG. 17 is a graph showing a main control area and an auxiliary control area in a slewing control of a crane executed by the slewing control device according to a second embodiment of the present invention.

FIG. 18 is a graph showing time transition of a lever operation amount, a pilot pressure, and an actual slewing angular velocity in the slewing control executed by the slewing control device according to the second embodiment of the present invention.

FIG. 19 is a hydraulic circuit diagram of a slewing drive unit of the crane according to a third embodiment of the present invention.

FIG. 20 is a graph showing the relationship between an operation amount of an operation lever and secondary pressure of electromagnetic proportional valves in the slewing control performed by a slewing control device according to the third embodiment of the present invention.

FIG. 21 is a graph showing the relationship between the secondary pressure of the electromagnetic proportional valves and a slewing angular velocity of an upper slewing body in the slewing control performed by the slewing control device according to the third embodiment of the present invention.

FIG. 22 is a flowchart of the slewing control of the crane performed by the slewing control device according to the third embodiment of the present invention.

FIG. 23 is a side view of a crane including a slewing control device according to a modified embodiment of the present invention.

FIG. 24 is a graph showing time transition of a lever operation amount, a pilot pressure, and an actual slewing angular velocity in the slewing control executed by another slewing control device compared with the slewing control device according to each embodiment of the present invention.

### DESCRIPTION OF EMBODIMENTS

### First Embodiment

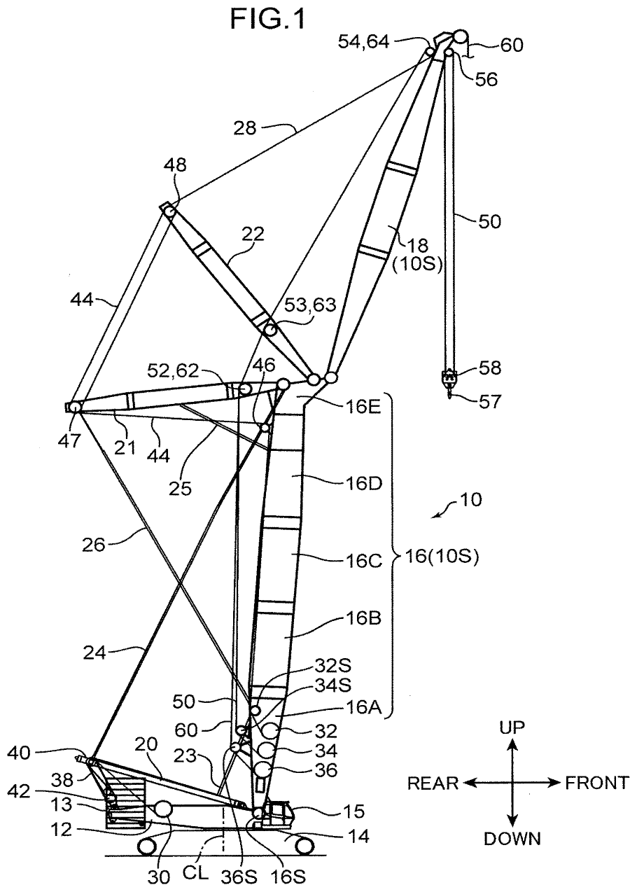

Embodiments of the present invention will be described below with reference to the drawings. FIG. 1 is a side view of a crane 10 according to a first embodiment of the present invention. Hereinafter, each drawing includes indication of directions of “up”, “down”, “front”, and “rear”. These directions are indicated for convenience in description of a structure and an assembling method of the crane 10 according to each embodiment, and do not limit any movement direction, any use mode, or the like of the crane according to the present invention.

The crane 10 includes an upper slewing body 12 corresponding to a crane body, a lower travelling body 14 (lower body) that slewably supports the upper slewing body 12, an attachment 10S (also referred to as a derricking part) including a boom 16 and a jib 18, and a mast 20 that is a boom derricking member. The upper slewing body 12 is supported by the lower travelling body 14 to be slewable about a slewing center axis CL extending in an up-and-down direction with respect to the lower travelling body 14. A counterweight 13 for adjusting the balance of the crane 10 is loaded on the rear portion of the upper slewing body 12. A cab 15 is provided at a front end of the upper slewing body 12. The cab 15 corresponds to a driver's seat of the crane 10.

The attachment 10S includes a proximal end supported by the upper slewing body 12 so as to be pivotable in a hoisting direction and a distal end opposite the proximal end, and is detachable from the upper slewing body 12. As described above, in the present embodiment, the attachment 10S includes the boom 16 and the jib 18.

The boom 16 shown in FIG. 1 is a so-called lattice type and includes a lower boom 16A, one or more (three in the illustrative example) intermediate booms 16B, 16C, and 16D, and an upper boom 16E. Specifically, the lower boom 16A is coupled to the front of the upper slewing body 12 pivotably in the hoisting direction. The intermediate booms 16B, 16C, and 16D are detachably joined in that order to the distal side of the lower boom 16A. The upper boom 16E is detachably joined to the distal side of the intermediate boom 16D. The jib 18, and a rear strut 21 and a front strut 22 for pivoting the jib 18 are each pivotably coupled to the distal end of the upper boom 16E. The boom 16 is supported by the upper slewing body 12 so as to be pivotable about a rotation axis extending in a left-right direction with a boom foot pin 16S provided at a lower end as a fulcrum.

The boom 16 includes an intermediate boom sheave 46 and respective idler sheaves 32S, 34S, and 36S. The intermediate boom sheave 46 is disposed on the rear side surface of the distal side of the intermediate boom 16D. The idler sheave 32S, the idler sheave 34S, and the idler sheave 36S are rotatably supported by the rear side surface of the proximal end of the boom 16.

However, the specific structure of the boom is not limited in the present invention. For example, the boom may have no intermediate member, or may have a different number of intermediate members. Furthermore, the boom may include a single member.

The specific structure of the jib 18 is also not limited. A proximal end of the jib 18 is pivotably coupled to (supported by) the distal end of the upper boom 16E of the boom 16, and a pivotal axis of the jib 18 is a transverse axis parallel to a pivotal axis of the boom 16 with respect to the upper slewing body 12 (boom foot pin 16S).

The mast 20 includes a proximal end and a pivotal end, and the proximal end is pivotably coupled to the upper slewing body 12. A pivotal axis of the mast 20 is parallel to the pivotal axis of the boom 16 and is located immediately rearward of the pivotal axis of the boom 16. In other words, this mast 20 is pivotable in the same direction as the hoisting direction of the boom 16. Meanwhile, the pivotal end of the mast 20 is coupled to the distal end of the boom 16 via a pair of left and right boom guy lines 24. This coupling allows the pivot of the mast 20 and the pivot of the boom 16 to cooperate with each other.

Furthermore, the crane 10 includes one pair of left and right backstops 23, the rear strut 21, the front strut 22, one pair of left and right strut backstops 25 and guy lines 26, and one pair of left and right jib guy lines 28.

The one pair of left and right backstops 23 are provided on left and right sides of the lower boom 16A of the boom 16. These backstops 23 abut on the central portion of the upper slewing body 12 in the front-rear direction when the boom 16 reaches the standing posture shown in FIG. 1. This abutment restricts the boom 16 from being blown backward by strong wind or the like.

The rear strut 21 is pivotably supported by the distal end of the boom 16. The rear strut 21 is held in a posture protruding from the tip of the upper boom 16E to the boom standing side (left side in FIG. 1). As a means for holding this posture, the one pair of left and right strut backstops 25 and the one pair of left and right guy lines 26 are interposed between the rear strut 21 and the boom 16. The guy lines 26 are stretched to connect the distal end of the rear strut 21 to the lower boom 16A of the boom 16, and regulates the position of the rear strut 21 by tension thereof.

The front strut 22 is disposed rearward of the jib 18, and is pivotably supported by the distal end of the boom 16 (upper boom 16E) so as to pivot together with the jib 18. In detail, the pair of left and right jib guy lines 28 is stretched to couple a distal end of the front strut 22 to a distal end of the jib 18. Therefore, this pivotable drive of the front strut 22 also drives the jib 18 to pivot integrally with the front strut 22.

The crane 10 further includes various winches. Specifically, the crane 10 includes a boom hoisting winch 30 for hoisting the boom 16, a jib hoisting winch 32 for pivoting the jib 18 in the hoisting direction, and a main winding winch 34 and an auxiliary winding winch 36 for winding up and down the hoist cargo. The crane 10 includes a boom hoisting rope 38, a jib hoisting rope 44, a main winding rope 50 (hoist cargo rope), and an auxiliary winding rope 60.

In the crane 10 according to the present embodiment, the jib hoisting winch 32, the main winding winch 34, and the auxiliary winding winch 36 are installed near the proximal end of the boom 16. The boom hoisting winch 30 is installed on the upper slewing body 12. Positions of these winches 30, 32, 34, and 36 are not limited to the above-described positions.

The boom hoisting winch 30 winds up and pays out the boom hoisting rope 38. Then, the boom hoisting rope 38 is routed such that the mast 20 is pivoted by the winding up and paying out. Specifically, sheave blocks 40 and 42 each having a plurality of sheaves arranged in the width direction are provided at the pivotal end of the mast 20 and the rear end of the upper slewing body 12, and the boom hoisting rope 38 drawn from the boom hoisting winch 30 is put between the sheave blocks 40 and 42. Therefore, by the boom hoisting winch 30 winding up and paying out the boom hoisting rope 38, the distance between both sheave blocks 40 and 42 changes, whereby the mast 20 and the boom 16 interlocked therewith pivot in the hoisting direction.

The jib hoisting winch 32 winds up and pays out the jib hoisting rope 44 that is put between the rear strut 21 and the front strut 22. Then, the jib hoisting rope 44 is routed such that the front strut 22 is pivoted by the winding up and paying out. Specifically, the jib hoisting rope 44 drawn from the jib hoisting winch 32 is put round the idler sheave 32S and the intermediate boom sheave 46, and is further put a plurality of times between the sheave blocks 47 and 48. Therefore, the jib hoisting winch 32 changes the distance between both sheave blocks 47 and 48 by winding up and paying out the jib hoisting rope 44, and causes the front strut 22 to relatively pivot with respect to the rear strut 21. As a result, the jib hoisting winch 32 raises and lowers the jib 18 interlocked with the front strut 22.

The main winding winch 34 winds up and down the hoist cargo with the main winding rope 50. The main winding rope 50 drawn from the main winding winch 34 is put round the idler sheave 34S, a rear strut idler sheave 52, a front strut idler sheave 53, and a main winding guide sheave 54 of FIG. 1 in this order, and is put between a main winding point sheave 56 of the sheave block and a sheave 58 of the sheave block provided in a main hook 57 for hoist cargo. Therefore, when the main winding winch 34 winds up or pays out the main winding rope 50, the distance between both sheaves 56 and 58 changes, and the main hook 57 coupled to the main winding rope 50 hanging down from the tip of the jib 18 is wound up and down. In this way, in the present embodiment, the main winding rope 50 (hoist cargo rope) hangs down from the distal end of the attachment 10S and is connected to the hoist cargo via the main hook 57.

Similarly, the auxiliary winding winch 36 winds up and down the hoist cargo with the auxiliary winding rope 60. The auxiliary winding rope 60 drawn from the auxiliary winding winch 36 is put round the idler sheave 36S, a rear strut idler sheave 62, a front strut idler sheave 63, and an auxiliary winding guide sheave 64 of FIG. 1 in this order, and hangs down from the auxiliary winding point sheave. Therefore, when the auxiliary winding winch 36 winds up or pays out the auxiliary winding rope 60, an auxiliary hook for hoist cargo (not shown) coupled to the end of the auxiliary winding rope 60 is wound up or down.

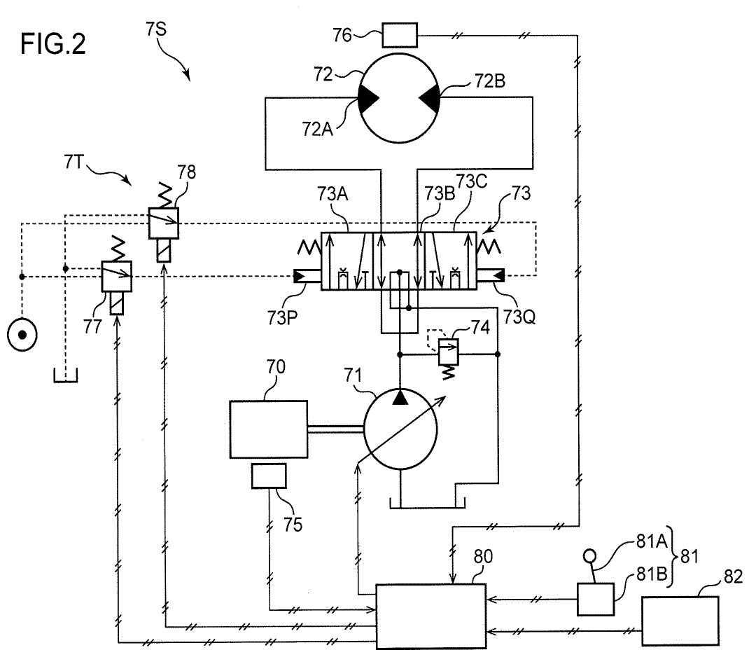

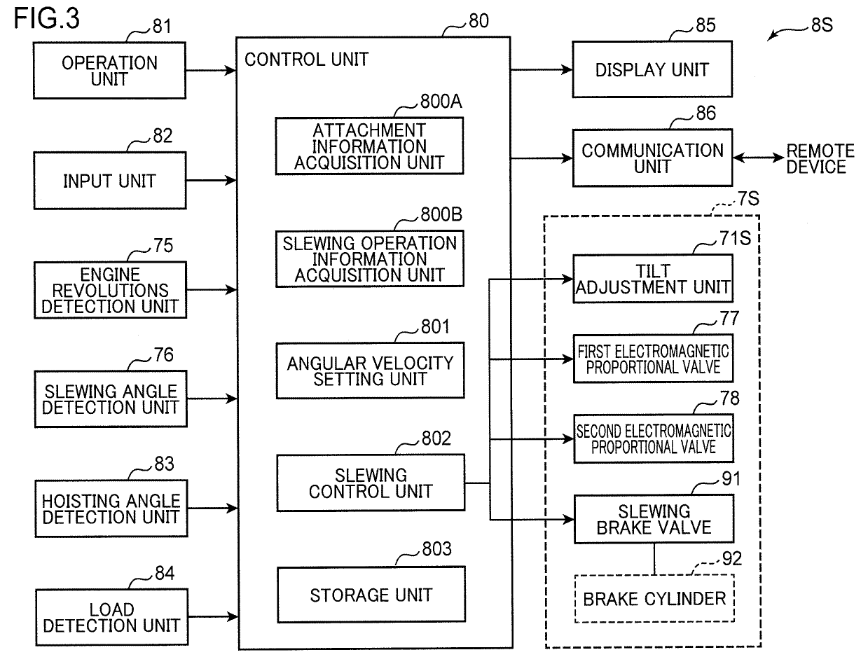

FIG. 2 is a hydraulic circuit diagram of a slewing drive unit 7S of the crane 10 according to the present embodiment. FIG. 3 is a block diagram of a slewing control device 8S according to the present embodiment. The crane 10 includes the slewing drive unit 7S and the slewing control device 8S. The slewing drive unit 7S can slew the upper slewing body 12 with respect to the lower travelling body 14 (slewing operation). When the slewing operation of the upper slewing body 12 is performed in the crane 10, to prevent damage in the attachment 10S (boom 16, jib 18), the slewing control device 8S slews the upper slewing body 12 while limiting the slewing angular velocity of the upper slewing body 12.

With reference to FIG. 2, the slewing drive unit 7S includes an engine 70, a hydraulic pump 71 including a tilt adjustment unit 71S (FIG. 3), a slewing motor 72, a control valve 73, a relief valve 74, an engine revolutions detection unit 75, a slewing angle detection unit 76, a first electromagnetic proportional valve 77, and a second electromagnetic proportional valve 78. The crane 10 further includes a control unit 80, an operation unit 81, and an input unit 82. Furthermore, with reference to FIG. 3, the crane 10 further includes a hoisting angle detection unit 83, a load detection unit 84, a display unit 85, and a communication unit 86.

The engine 70 includes an output shaft. In the present embodiment, the engine 70 can be switched between a HIGH idle mode and a LOW idle mode according to the worker's operation (input). The number of revolutions of the output shaft in the HIGH idle mode is set higher than the number of revolutions of the output shaft in the LOW idle mode. The HIGH idle mode is selected by the worker when working with a relatively large load.

The hydraulic pump 71 is coupled to the output shaft of the engine 70 and receives power input from the output shaft, and sucks from a tank and discharges hydraulic oil to be supplied to the slewing motor 72. This hydraulic pump 71 according to the embodiment includes a variable displacement type hydraulic pump. The capacity (push-off volume) of the hydraulic pump 71 changes by the input of a tilt command signal to the tilt adjustment unit 71S (regulator) included in the hydraulic pump 71, thereby changing the pump discharge flow rate, which is the flow rate of the hydraulic oil discharged from the hydraulic pump 71. In other words, the hydraulic pump 71 can receive input of the tilt command signal and change the maximum discharge amount of the hydraulic oil according to the magnitude of the tilt command signal. Note that the tilt command signal described above is output from a slewing control unit 802 of the control unit 80 to be described later (FIG. 3).

The slewing motor 72 is a hydraulic slewing motor that drives and slews the upper slewing body 12. The slewing motor 72 includes a plurality of hydraulic chambers inside, receives the hydraulic oil supplied from the hydraulic pump 71 to one of the plurality of hydraulic chambers, and discharges the hydraulic oil from another hydraulic chamber of the plurality of hydraulic chambers, thereby generating the driving force to slew the upper slewing body 12. Specifically, the slewing motor 72 is disposed to be interposed between the upper slewing body 12 and the lower travelling body 14 of FIG. 1. The slewing motor 72 includes a motor shaft including a pinion and is fixed to the upper slewing body 12. Meanwhile, the lower travelling body 14 includes a circumferentially formed slewing gear (not shown). The pinion of the slewing motor 72 and the slewing gear mesh with each other, whereby the upper slewing body 12 slews according to the rotation of the slewing motor 72. Therefore, the slewing motor 72 is disposed to be positioned near the circumference of the slewing gear. The slewing motor 72 includes a motor first port 72A and a motor second port 72B. The slewing motor 72 slews the upper slewing body 12 in a first direction (for example, left direction) by being supplied with the hydraulic oil through the motor first port 72A, and discharges the hydraulic oil through the motor second port 72B. Meanwhile, the slewing motor 72 slews the upper slewing body 12 in a second direction opposite the first direction (for example, right direction) by being supplied with the hydraulic oil through the motor second port 72B, and discharges the hydraulic oil through the motor first port 72A.

The control valve 73 is disposed in hydraulic oil path to be interposed between the hydraulic pump 71 and the slewing motor 72. The control valve 73 operates to switch the direction of hydraulic oil supply from the hydraulic pump 71 to the slewing motor 72, and to adjust the flow rate of the hydraulic oil. The control valve 73 is connected to each of the motor first port 72A and a motor second port 20B of the slewing motor 72.

The control valve 73 operates to switch among a left slewing position 73A (first slewing position), neutral position 73B (neutral slewing position), and right slewing position 73C (second slewing position) according to pilot pressure input to the control valve 73. The control valve 73 includes one pair of pilot ports, that is, a left slewing pilot port 73P and a right slewing pilot port 73Q. The control valve 73 is kept at the neutral position 73B when the pilot pressure is not input to either the left slewing pilot port 73P or the right slewing pilot port 73Q. The control valve 73 is switched to the left slewing position 73A when the pilot pressure is input to the left slewing pilot port 73P, and is switched to the right slewing position 73C when the pilot pressure is input to the right slewing pilot port 73Q. Then, the control valve 73 is opened with an opening area according to the pilot pressure to change the flow rate of the hydraulic oil.

At the left slewing position 73A, the control valve 73 forms an oil path that supplies the hydraulic oil discharged from the hydraulic pump 71 to the motor first port 72A and guides the hydraulic oil discharged from the motor second port 72B to the tank. At the right slewing position 73C, the control valve 73 forms an oil path that supplies the hydraulic oil discharged from the hydraulic pump 71 to the motor second port 72B and guides the hydraulic oil discharged from the motor first port 72A to the tank. At the neutral position 73B, the control valve 73 allows the hydraulic oil to circulate between the motor first port 72A and the motor second port 72B.

The relief valve 74 operates to prevent the pressure in the oil path (bleed off-line) between the control valve 73 and the tank from exceeding predetermined pressure.

The engine revolutions detection unit 75 detects the rotational speed (or the number of revolutions) of the output shaft of the engine 70. The slewing angle detection unit 76 detects a slewing angle of the slewing motor 72 (upper slewing body 12). As an example, the angle of the upper slewing body 12 in a state where the front direction of the upper slewing body 12 and the front direction of the lower travelling body 14 coincide with each other corresponds to 0 degrees. The slewing angle detection unit 76 detects the rotation direction of the slewing motor 72 (first direction or second direction). The slewing angle detection unit 76 may be an encoder, a potentiometer, or the like.

The operation unit 81 is disposed in the cab 15 (FIG. 1) and is operated by the worker for the hoisting operation of the attachment 10S and the slewing operation of the upper slewing body 12. The operation unit 81 regarding the slewing operation of the upper slewing body 12 will be described below. The operation unit 81 receives an operation for slewing the upper slewing body 12 with respect to the lower travelling body 14, outputs a slewing command signal according to the magnitude of the operation, and inputs the signal to the control unit 80. The operation unit 81 includes an operation lever 81A and a remote control unit 81B. The operation lever 81A can be selectively operated in a first operating area to slew the upper slewing body 12 in the first direction, a second operating area to slew the upper slewing body 12 in the second direction, and a neutral operating area between the first and second operating areas. The operation amount of the operation lever 81A in each of the first and second operating areas is variable.

When the operation lever 81A is operated by the worker in the first operating area (first slewing operation), the remote control unit 81B inputs a signal according to the operation amount the operation lever 81A receives to the control unit 80. When the operation lever 81A is operated by the worker in the second operating area (second slewing operation), the remote control unit 81B inputs a signal according to the operation amount the operation lever 81A receives to the control unit 80. As a result, a command signal is input from the control unit 80 to the first electromagnetic proportional valve 77 and the second electromagnetic proportional valve 78.

The first electromagnetic proportional valve 77 and the second electromagnetic proportional valve 78 adjust the pilot pressure input to the control valve 73 in response to the command signal given by the slewing control unit 802 of the control unit 80. Specifically, the first electromagnetic proportional valve 77 and the second electromagnetic proportional valve 78 are interposed between a pilot hydraulic source and the left slewing pilot port 73P and the right slewing pilot port 73Q of the control valve 73, and are connected to the left slewing pilot port 73P and the right slewing pilot port 73Q via pilot lines, respectively. The first electromagnetic proportional valve 77 opens to reduce the pilot pressure supplied to the left slewing pilot port 73P when the command signal is given from the slewing control unit 802 (FIG. 3). The second electromagnetic proportional valve 78 opens to reduce the pilot pressure supplied to the right slewing pilot port 73Q when the command signal is given from the slewing control unit 802. At this time, the stroke amount of the spool of the control valve 73 changes according to the change in the pilot pressure input to the left slewing pilot port 73P and the right slewing pilot port 73Q.

The input unit 82 receives input of various pieces of information by the worker. The information input from the input unit 82 is housed (stored) in a storage unit 803 of the control unit 80 to be described later. The worker can input (switch) on/off of performing slewing control performed by the slewing control device 8S according to the present embodiment through an operating switch (not shown) included in the input unit 82.

The hoisting angle detection unit 83 detects the hoisting angle of the attachment 10S, that is, relative angle with respect to the ground. In the present embodiment, the hoisting angle detection unit 83 can detect each of the hoisting angle (ground angle) of the boom 16 and the hoisting angle of the jib 18.

The load detection unit 84 detects the load of the hoist cargo (hoist cargo load) connected to the main winding rope 50 (auxiliary winding rope 60). The load detection unit 84 includes a tension sensor installed in the main winding winch 34 (auxiliary winding winch 36) and the like.

The display unit 85 is disposed in the cab 15 of the crane 10, and includes a display capable of displaying various types of information.

The communication unit 86 (transmission unit) can transmit each load information acquired by an attachment information acquisition unit 800A and a slewing operation information acquisition unit 800B of the control unit 80 in association with the maximum slewing angular velocity set by an angular velocity setting unit 801. The communication unit 86 transmits the above information to a remote device disposed at a position away from the crane. The remote device receives and manages the load information and the maximum slewing angular velocity transmitted by the communication unit 86.

The control unit 80 controls the entire operation of the crane 10, and is electrically connected to the operation unit 81, the input unit 82, the engine revolutions detection unit 75, the slewing angle detection unit 76, the hoisting angle detection unit 83, the load detection unit 84, the tilt adjustment unit 71S, the first electromagnetic proportional valve 77, the second electromagnetic proportional valve 78, and the like as a destination of sending and receiving the control signal. Note that the control unit 80 is also electrically connected to other units provided in the crane 10.

The control unit 80 includes a central processing unit (CPU), a read only memory (ROM) to store a control program, a random access memory (RAM) used as a work area for the CPU, and the like. By the CPU executing the control program, the control unit 80 operates to functionally include an attachment information acquisition unit 800A (load information acquisition unit), a slewing operation information acquisition unit 800B (load information acquisition unit), an angular velocity setting unit 801, the slewing control unit 802, and the storage unit 803. Each of these functional units is a unit of a function executed by the control unit 80.

The attachment information acquisition unit 800A acquires attachment information (load information). The attachment information is information for setting the maximum slewing angular velocity, which is the maximum value of the slewing angular velocity, based on a transverse load acting on the attachment 10S. As one example, the attachment information is information peculiar to the attachment 10S related to at least one of the strength of the attachment 10S against the transverse load and the magnitude of the transverse load. That is, the attachment information is information equipped by the attachment 10S even with the attachment 10S detached from the upper slewing body 12. The transverse load is a load along a slewing direction of the upper slewing body 12, acting on the attachment 10S, along with the slewing operation of the upper slewing body 12, more specifically, a tangential direction in plan view in the slewing operation of the upper slewing body 12. As one example, the attachment information includes the length of the attachment 10S from the proximal end to the distal end, and is input by the worker through the input unit 82.

The slewing operation information acquisition unit 800B (load information acquisition unit) acquires slewing operation information (load information). The slewing operation information is information for setting the maximum slewing angular velocity based on a transverse load. As described above, the transverse load is a load acting on the attachment 10S due to the slewing angular velocity of the upper slewing body 12 along the slewing direction of the upper slewing body 12. In other words, the slewing operation information is information related to the condition of the slewing operation of the upper slewing body 12 for setting the maximum slewing angular velocity. The slewing operation information is information about the condition of the slewing operation of the upper slewing body 12 with the attachment 10S attached to the upper slewing body 12, and is information related to the magnitude of the transverse load. As one example, the slewing operation information includes the hoist cargo load, the working radius of the attachment 10S, and the like. As described later, the working radius is the distance from the proximal end to the distal end of the attachment 10S (jib 18) in plan view.

Based on at least one of the attachment information acquired by the attachment information acquisition unit 800A and the slewing operation information acquired by the slewing operation information acquisition unit 800B, the angular velocity setting unit 801 sets a maximum slewing angular velocity that is a maximum value of a slewing angular velocity of the upper slewing body 12 allowed in a slewing operation of the upper slewing body 12. The angular velocity setting unit 801 may set the maximum slewing angular velocity based on both of the attachment information acquired by the attachment information acquisition unit 800A and the slewing operation information acquired by the slewing operation information acquisition unit 800B.

The slewing control unit 802 receives the slewing command signal output from the operation unit 81 and controls the slewing drive unit 7S such that the upper slewing body 12 slews with respect to the lower travelling body 14 in response to the slewing command signal. The slewing control unit 802 controls the slewing drive unit 7S such that the slewing angular velocity of the upper slewing body 12 does not exceed the maximum slewing angular velocity that is set by the angular velocity setting unit 801. In the present embodiment, the slewing control unit 802 limits the discharge amount of the hydraulic oil to be discharged from the hydraulic pump 71 such that the slewing angular velocity of the upper slewing body 12 does not exceed the set maximum slewing angular velocity, by inputting the tilt command signal corresponding to the maximum slewing angular velocity that is set by the angular velocity setting unit 801 into the hydraulic pump 71.

The storage unit 803 houses and outputs information such as various parameters and thresholds to be referred to by the slewing control device 8S in the operation of the crane 10. The storage unit 803 stores a limit value map described later to be referred to by the angular velocity setting unit 801.

Note that the control valve 73, the first electromagnetic proportional valve 77, and the second electromagnetic proportional valve 78 constitute a flow rate adjustment mechanism 7T according to the present embodiment. The flow rate adjustment mechanism 7T adjusts the flow rate of the hydraulic oil supplied to the slewing motor 72, out of the hydraulic oil discharged from the hydraulic pump 71 in response to a command received from the slewing control unit 802 of the control unit 80. The engine 70, the hydraulic pump 71, the slewing motor 72, and the flow rate adjustment mechanism 7T constitute the slewing drive unit 7S described above. Furthermore, the control unit 80, the engine revolutions detection unit 75, the slewing angle detection unit 76, the hoisting angle detection unit 83, and the load detection unit 84 constitute the slewing control device 8S in the present embodiment. The slewing control device 8S is used for the crane 10. A brake valve 91 and a brake cylinder 92 in FIG. 3 will be described in a third embodiment described later.

Note that FIG. 2 shows the hydraulic circuit related to the slewing operation of the upper slewing body 12 of the crane 10, but the crane 10 includes a hydraulic circuit (not shown) related to the travelling operation of the lower travelling body 14, the hoisting operation of the boom 16 and the jib 18, and the winding up and down operation of the main winding rope 50 and the auxiliary winding rope 60. In the hoisting operation of the boom 16 and the jib 18, the boom hoisting winch 30 and the jib hoisting winch 32 are driven to rotate in response to the operation input to the operation unit 81, respectively. In the winding up and down operation of the main winding rope 50 and the auxiliary winding rope 60, the main winding winch 34 and the auxiliary winding winch 36 are driven to rotate in response to the operation input to the operation unit 81, respectively.

### <Swing of Attachment in Slewing Operation>

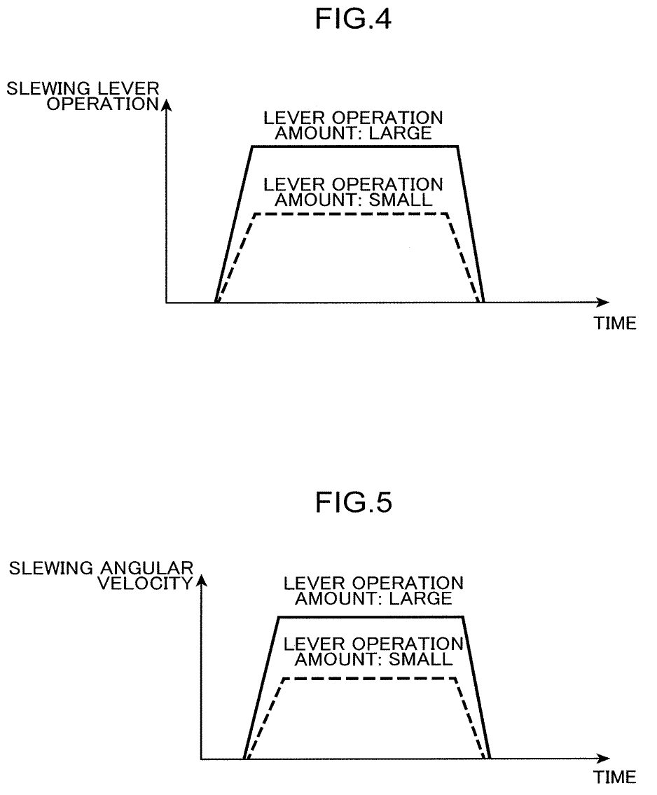

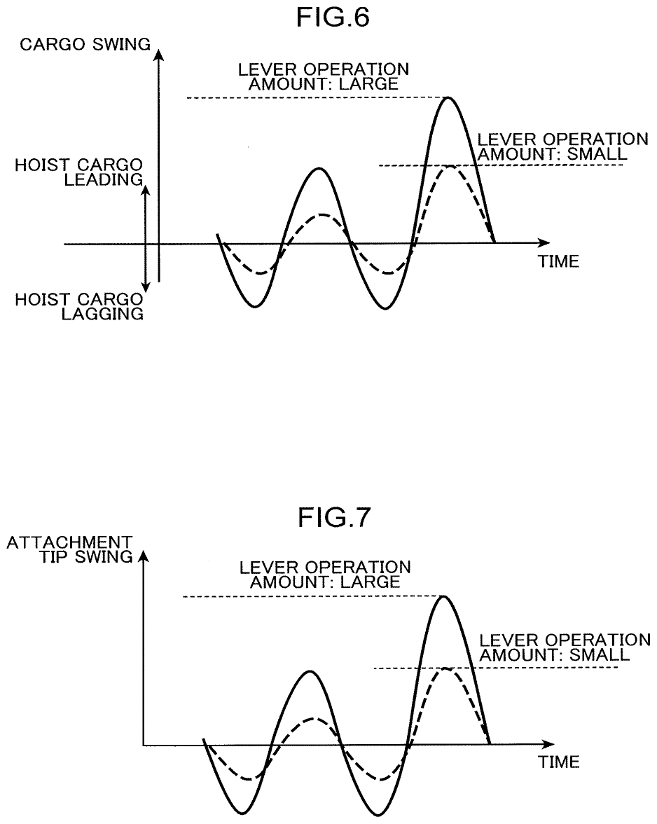

FIG. 4 is a graph showing the change of the operation amount received by the operation lever 81A when the crane 10 performs the slewing operation. FIG. 5 is a graph showing the change of the slewing angular velocity of the upper slewing body 12 when the crane 10 performs the slewing operation. FIG. 6 is a graph showing the change of the cargo swing amount of the hoist cargo when the crane 10 performs the slewing operation. FIG. 7 is a graph showing the change of the swing amount of the attachment tip when the crane 10 performs the slewing operation.

In a case where the upper slewing body 12 slews with the hoist cargo connected to the main winding rope 50 (main hook 57) of the crane 10, when the worker operates the operation lever 81A as shown in FIG. 4, the slewing drive unit 7S slews the upper slewing body 12 according to the operation amount, thereby changing the slewing angular velocity of the upper slewing body 12 as shown in FIG. 5. As the operation amount of the worker operating the operation lever 81A increases, the slewing angular velocity of the upper slewing body 12 increases (FIG. 5).

In such a slewing operation of the upper slewing body 12, a large cargo swing may occur depending on how the worker operates the operation lever. For example, when the upper slewing body 12 starts slewing at the time of starting the slewing operation, since the hoist cargo has inertia, the hoist cargo starts slewing with a lag behind the upper slewing body 12. After that, the hoist cargo moves so as to overtake the upper slewing body 12 due to the pendular movement of the hoist cargo. As a result, as shown in FIG. 6, the movement of the hoist cargo repeating lead, lag, and lead with respect to the upper slewing body 12 (cargo swing) is generated. At this time, if the worker decelerates the upper slewing body 12 at the timing when the hoist cargo is ahead of the upper slewing body 12, the hoist cargo tries to further go ahead of the upper slewing body 12 because of the inertial force of the hoist cargo, causing a large cargo swing (peak portion on the right end of FIG. 6). That is, if the phase of cargo swing during acceleration of the slewing operation (relative movement direction of the hoist cargo with respect to the upper slewing body 12) is the same as the phase of cargo swing during deceleration, the amplitude of the cargo swing overlaps, leading to an increase in the amplitude of the cargo swing.

If such cargo swing amplification occurs, the transverse load acts on the attachment 10S as well, and therefore similar swing also occurs in the distal end of the attachment 10S (FIG. 7), and stress due to this swing also occurs. As the load of the hoist cargo increases (heavy load), the transverse load acting on the attachment 10S increases, and therefore the swing of the attachment 10S also increases. The stress acting on the attachment 10S is also large when the load is heavy. Even when the upper slewing body 12 slews with the same slewing angular velocity, if the attachment 10S is long, the peripheral speed of the distal end increases, and thus the above-described phenomenon becomes more remarkable.

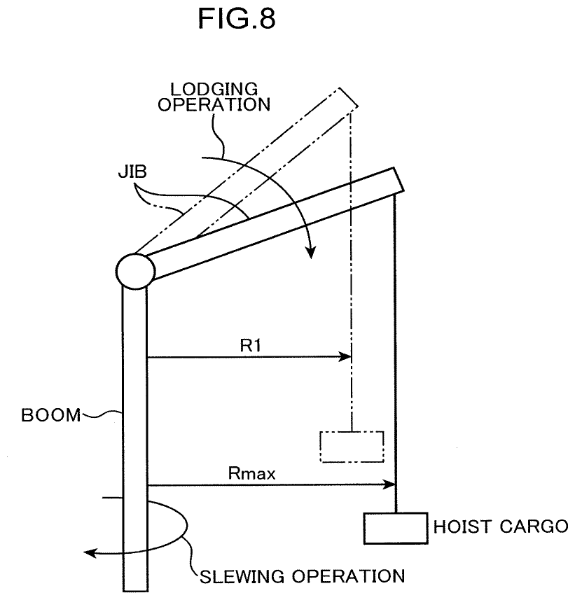

FIG. 8 is a schematic diagram for explaining a working radius of the crane according to the present embodiment. With reference to FIG. 8, even if the load of the hoist cargo hanging down from the distal end of the attachment 10S (jib 18) is the same, if the working radius R1 changes because the attachment 10S is hoisted (hoisting angle changes), the swing of the tip of the attachment 10S and the stress acting on the attachment 10S will change. In particular, when the attachment 10S lodges and the working radius R1 increases, the load on the attachment 10S increases. Therefore, in the crane 10, the maximum value Rmax of the working radius is set in advance. The occurrence of swing, transverse load, stress, and the like caused by various conditions as described above may cause damage or breakage to a part of the attachment 10S.

### <Setting of Maximum Slewing Angular Velocity>

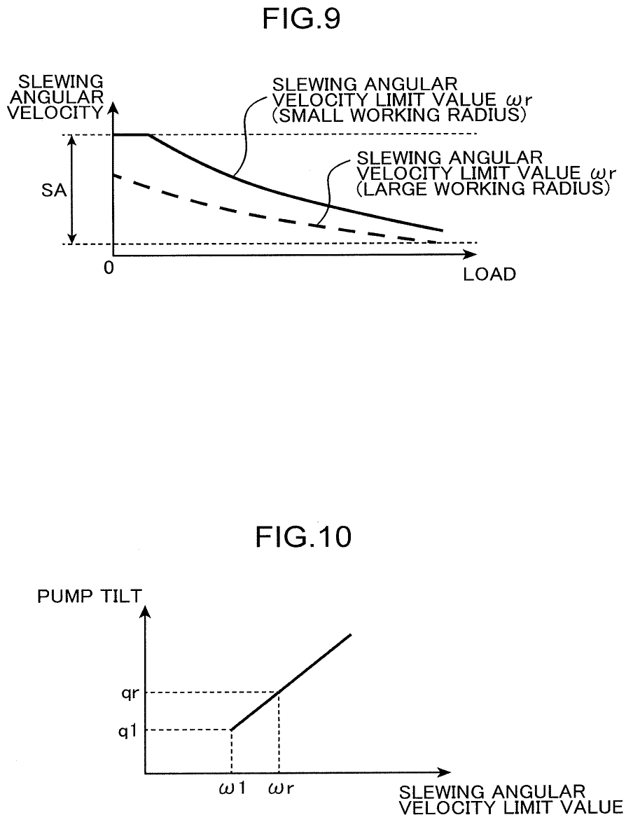

FIG. 9 is a graph of the slewing angular velocity limit value set in the slewing control device 8S according to the present embodiment. FIG. 10 is a graph showing the relationship between the slewing angular velocity limit value set by the slewing control device 8S and the pump tilt of the hydraulic pump 71.

In the present embodiment, an allowable value of swing of the attachment 10S for safely operating the crane 10 is set in advance, and as shown in FIG. 9, a slewing angular velocity (slewing angular velocity limit value ωr, maximum slewing angular velocity) for satisfying the allowable value is set according to the load. The load on the horizontal axis in FIG. 9 corresponds to the load of the hoist cargo. As shown in FIG. 9, the slewing angular velocity limit value ωr is set to be smaller as the load of the hoist cargo increases. The slewing angular velocity limit value ωr is set to be relatively smaller when the working radius is large than when the working radius is small. The limit value is created by evaluating the cargo swing amount, swing amount of the attachment 10S, stress, and the like through advance offline analysis and experiments, and stored in the storage unit 803.

In the present embodiment, in limiting the slewing angular velocity of the upper slewing body 12 as described above, the pump tilt of the hydraulic pump 71 is adjusted as shown in FIG. 10. As a result, the discharge amount of the hydraulic oil of the hydraulic pump 71 is adjusted, and the inflow amount (inflow speed) of the hydraulic oil flowing into the slewing motor 72 is adjusted. Therefore, the slewing angular velocity of the upper slewing body 12 can be adjusted.

In the hydraulic pump 71, due to its characteristics, the ratio between the maximum capacity and the minimum capacity is determined in advance, and the ratio between the maximum angular velocity and the minimum angular velocity in the slewing operation of the upper slewing body 12 is also determined by the ratio of the capacity. For this reason, in order to satisfy the maximum angular velocity required for the slewing angular velocity from the specification of the crane 10, the minimum angular velocity is also inevitably determined. Therefore, the slewing angular velocity cannot be controlled to a velocity equal to or less than the minimum angular velocity, and the angular velocity of the upper slewing body 12 may not be controlled to a preset slewing angular velocity limit value ωr (maximum slewing angular velocity) or less. In FIG. 10 described above, the relationship between a slewing angular velocity limit value ωr and a pump tilt qr is shown, and the slewing angular velocity corresponding to a minimum value q1 of the pump tilt corresponds to ω1 (minimum slewing angular velocity). That is, due to the characteristics of the hydraulic pump 71, it is difficult to forcibly suppress the slewing angular velocity of the upper slewing body 12 to the minimum slewing angular velocity ω1 or less by tilt adjustment.

In addition, when the wind acts in the tailwind direction with respect to the slewing direction of the attachment 10S at the work site, there is a possibility that the slewing angular velocity of the upper slewing body 12 is accelerated and exceeds the set slewing angular velocity limit value ωr. Similarly, when the weight of the attachment acts in the slewing direction due to the ground inclination at the work site, the slewing angular velocity of the upper slewing body 12 may be increased to exceed the set slewing angular velocity limit value ωr.

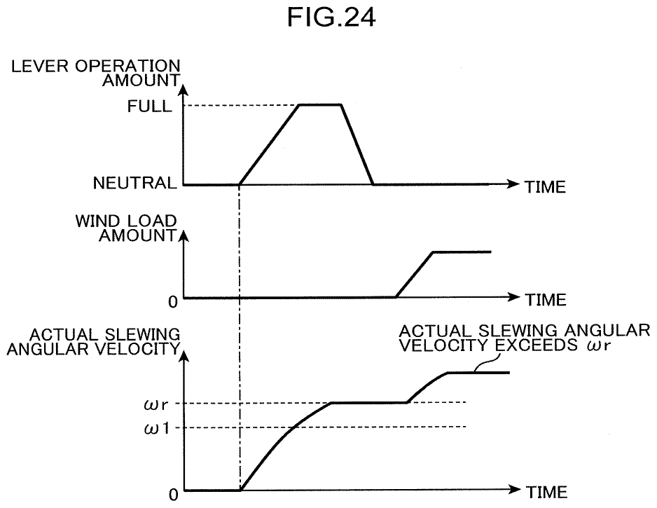

FIG. 24 is a graph showing time transition of the lever operation amount, the pilot pressure, and the actual slewing angular velocity in the slewing control executed by another slewing control device compared with the slewing control device 8S according to each embodiment of the present invention. In FIG. 24, a plurality of graphs are integrated into one diagram by matching time with each other. The same applies to some of the other graphs described later. FIG. 24 illustrates a state in which the actual slewing angular velocity of the upper slewing body 12 is limited to the slewing angular velocity limit value ωr by the tilt adjustment when the operation lever is operated from the neutral position to the maximum operation amount (FULL) in the hydraulic circuit having the neutral free (slewing free) structure, but exceeds the slewing angular velocity limit value ωr under the influence of the wind load. As described above, in a case where the load is large or in a case where the working radius is large, there is a possibility that it is difficult to perform control to the minimum slewing angular velocity ω1 or less only by the tilt control of the hydraulic pump 71. In addition, when the operation lever amount of the operation unit 81 is forcibly controlled in lever control (proportional valve control) to be described later, the slewing torque of the slewing motor 72 decreases and the wind load may be lost. Therefore, it may be difficult to control the actual slewing angular velocity to be equal to or less than the minimum slewing angular velocity ω1 corresponding to the lever amount with which the necessary slewing torque can be secured. Furthermore, even when ω1<ωr, the slewing angular velocity may increase due to the influence of the wind load and the ground inclination, and the actual slewing angular velocity may exceed ωr. In particular, in the case of the known neutral free structure, since the hydraulic brake is not applied only by returning the operation lever to the neutral position, the actual slewing angular velocity may increase and exceed ωr due to the wind load and the ground inclination.

In the present embodiment, as described above, in limiting the slewing angular velocity of the upper slewing body 12, even when the slewing angular velocity is about to exceed the slewing angular velocity limit value ωr unintentionally, it is possible to promptly notify the operator who operates the crane 10 of the information and to reduce the slewing angular velocity of the upper slewing body 12. Hereinafter, the flow of the control will be described in detail.

### <Slewing Control of Upper Slewing Body 12>

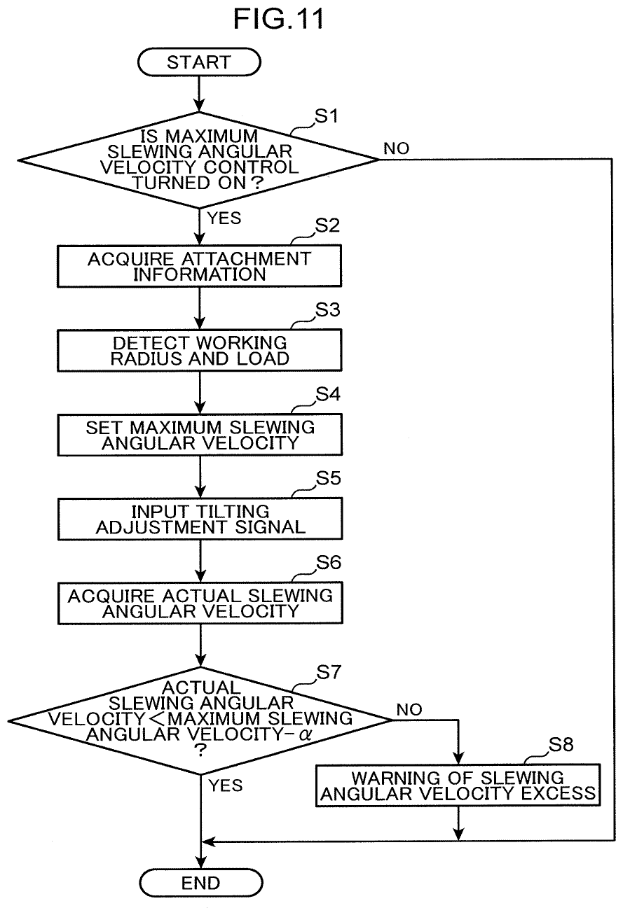

FIG. 11 is a flowchart of the slewing control of the crane 10 performed by the slewing control device 8S according to the present embodiment. The slewing control of the upper slewing body 12 using the limit value of the slewing angular velocity as described above will be described in detail below.

With reference to FIG. 11, when the worker operates the operation lever 81A regarding the slewing operation and a signal according to the operation is input from the remote control unit 81B to the control unit 80, the angular velocity setting unit 801 determines whether an execution switch of maximum slewing angular velocity control is turned on (step S1). Here, when the execution switch is turned on (YES in step S1), the angular velocity setting unit 801 acquires the attachment information from the storage unit 803 (step S2). In the present embodiment, as described above, the length information on the attachment 10S is acquired. Note that the length of the attachment 10S is the sum of the length of the boom 16 and the length of the jib 18.

Next, the hoisting angle detection unit 83 detects the hoisting angles of the boom 16 and the jib 18, and the load detection unit 84 detects the load of the hoist cargo. The angular velocity setting unit 801 calculates a working radius R1 of FIG. 8 based on the cosine corresponding to the hoisting angle detected by the hoisting angle detection unit 83 and the lengths of the boom 16 and the jib 18 acquired in advance. As a result, the working radius and the load of the hoist cargo are detected (step S3 in FIG. 11).

Next, based on the load information acquired above, the angular velocity setting unit 801 sets the slewing angular velocity limit value ωr (maximum slewing angular velocity) with reference to the limit value map (FIG. 9) stored in the storage unit 803 (step S4).

Next, based on the slewing angular velocity limit value ωr set above, the slewing control unit 802 performs the slewing control of the upper slewing body 12 while limiting the slewing angular velocity of the upper slewing body 12. Specifically, by controlling the tilt of the hydraulic pump 71 and limiting the maximum flow rate of the hydraulic oil supplied from the hydraulic pump 71 through the control valve 73 to the slewing motor 72, the slewing control unit 802 limits the slewing angular velocity limit value ωr of the upper slewing body 12. At this time, the slewing control unit 802 inputs the tilt adjustment command signal corresponding to the slewing angular velocity limit value ωr to the tilt adjustment unit 71S (FIG. 3). As a result, the maximum discharge amount of the hydraulic pump 71 is limited, and the slewing angular velocity of the upper slewing body 12 is adjusted to be equal to or less than the slewing angular velocity limit value ωr.

On the other hand, as described above, there is a possibility that the actual slewing angular velocity (actual slewing angular velocity) exceeds the slewing angular velocity limit value ωr due to the characteristics of the hydraulic pump 71, the wind at the work site, the ground inclination, and the like. Therefore, the slewing control unit 802 calculates and acquires the actual slewing angular velocity from the detection result of the slewing angle detection unit 76 (step S6).

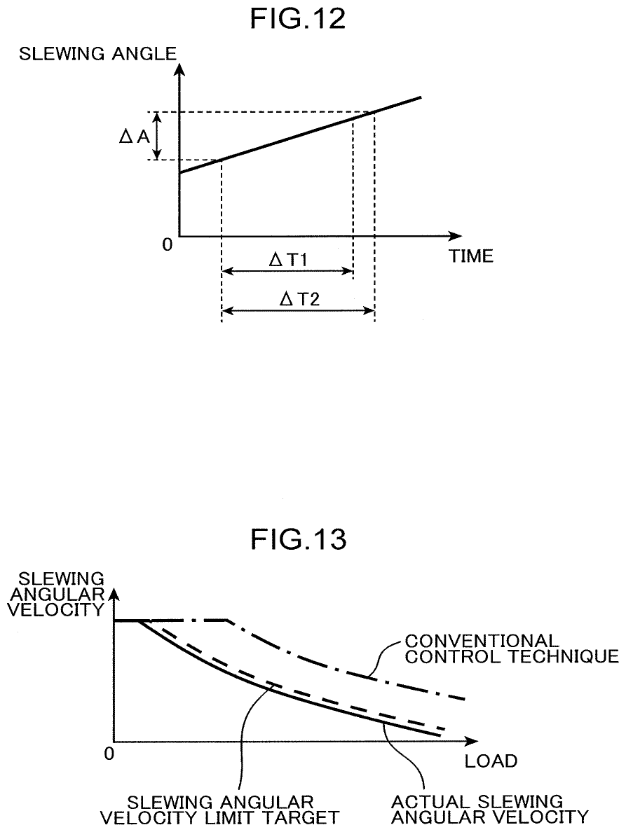

FIG. 12 is a graph for explaining a method of calculating the actual slewing angular velocity in the slewing control device 8S according to the present embodiment. In the present embodiment, the slewing control unit 802 calculates the actual slewing angular velocity of the upper slewing body 12 from the difference between the two slewing angles detected by the slewing angle detection unit 76 at each of a first time and a second time and the time interval between the first time and the second time. As a result, it is not necessary to mount a device that directly detects the slewing angular velocity, and the slewing angular velocity can be detected using the slewing angle detection unit 76. Specifically, as shown in FIG. 12, it is calculated by the actual slewing angular velocity=(slewing angle change ΔA)/(time interval ΔT2). Here, the time interval ΔT1 is a time interval on the specification of the controller of the control unit 80, and the time interval ΔT2 represents an actual time interval. As described above, in the present embodiment, the time interval ΔT2 (actual time interval) measured by a timer (real-time measurement unit) or the like included in the control unit 80 is used in the calculation of the actual slewing angular velocity instead of ΔT1 (the actual time interval may be different depending on the specification value and the processing amount of the controller) as described above.

In other words, the controller sets the first time and the second time based on the system time. The time interval between the first time and the second time is ΔT1 on the system time. On the other hand, the time interval between the first time and the second time measured by a timer or the like is ΔT2. The time interval measured by the timer is counted independently with respect to the system time of the controller.

The slewing angle is acquired from the slewing angle detection unit 76 to the control unit 80 in each control cycle of the controller. Therefore, the time change can be expressed as controller control cycle×N control cycles, but N may be 1 or a value larger than 1 (for example, N=5 or 10). When N=1, the responsiveness is high, but the fluctuation of the calculated value of the slewing angular velocity is slightly large. In addition, in the case of N=5, 10, and the like, since the average slewing angular velocity for N control cycles is calculated, the responsiveness is delayed, but the fluctuation of the calculated value of the slewing angular velocity becomes small. When the fluctuation of the slewing angular velocity calculated in each cycle is large, filter processing such as moving average processing may be performed. As described above, the accuracy of the calculated value of the slewing angular velocity can be improved by using the real-time measured value as the time interval instead of the time interval (the time interval based on the system time) in the specification of the controller.

Next, the slewing control unit 802 compares the actual slewing angular velocity calculated above with the maximum slewing angular velocity set by the angular velocity setting unit 801 (step S7). At this time, in consideration of the overshoot of the control, in order to suppress the actual slewing angular velocity from greatly exceeding the maximum slewing angular velocity, a magnitude relationship between a value obtained by subtracting the preset constant a from the maximum slewing angular velocity and the actual slewing angular velocity is compared. Then, when the actual slewing angular velocity is less than (maximum slewing angular velocity−α) (YES in step S7), the flow of FIG. 11 ends. Note that, during the slewing operation of the upper slewing body 12, the flow of FIG. 11 is repeated.

On the other hand, when the actual slewing angular velocity is equal to or greater than (the maximum slewing angular velocity−α) in step S7 (NO in step S7), the control unit 80 issues a warning of the slewing angular velocity excess (step S8). Specifically, the slewing control unit 802 outputs an auxiliary command signal for reducing the slewing angular velocity, and inputs the auxiliary command signal to the display unit 85 (FIG. 3). As a result, in response to the auxiliary command signal output from the slewing control unit 802, the display unit 85 (warning unit) warns a worker who can operate the operation unit 81 (FIG. 3) in the cab 15 that the actual slewing angular velocity of the upper slewing body 12 approaches the maximum slewing angular velocity or exceeds the maximum slewing angular velocity. Note that the warning may be notified or warned by sound information, buzzer sound, or the like in addition to the display image displayed on the display unit 85, or the operation lever of the operation unit 81 may vibrate. In addition, the warning is not limited to the display unit 85 in the cab 15, and may be issued by a remote device that remotely operates the crane 10, a tablet held by a worker at a work site, or the like.

In the present embodiment, when the slewing angular velocity of the upper slewing body 12 approaches the slewing angular velocity limit value ωr, it is possible to output an auxiliary command signal to display a warning regardless of the magnitude of the load. Therefore, as shown in the vertical axis of the graph of FIG. 9, the auxiliary command signal can be output in a wide range of the auxiliary control arca SA.

Note that in step S1 of FIG. 11, when the execution switch of the maximum slewing angular velocity control is not turned on (NO in step S1), normal slewing control (control that does not limit the maximum slewing angular velocity) is performed without performing the maximum slewing angular velocity control.

As described above, in the present embodiment, the angular velocity setting unit 801 sets the maximum slewing angular velocity (slewing angular velocity limit value ωr). The maximum slewing angular velocity is a maximum value of the slewing angular velocity of the upper slewing body 12 allowed in the slewing operation of the upper slewing body 12 based on the load information. Furthermore, the slewing control unit 802 receives the slewing command signal output from the operation unit 81 and controls the slewing drive unit 7S such that the upper slewing body 12 slews with respect to the lower travelling body 14 in response to the slewing command signal. At this time, the slewing control unit 802 controls the slewing drive unit 7S such that the slewing angular velocity of the upper slewing body 12 does not exceed the maximum slewing angular velocity that is set by the angular velocity setting unit 801.

With such a configuration, since the angular velocity setting unit 801 sets the maximum slewing angular velocity in the slewing operation of the upper slewing body 12 according to the load information, it is possible to efficiently inhibit the attachment 10S from being damaged or broken due to a large transverse load applied to the attachment 10S.

On the other hand, even when the desirable control as described above is performed, the slewing angular velocity of the upper slewing body 12 may approach or exceed the slewing angular velocity limit value ωr due to the characteristics of the hydraulic circuit including the hydraulic pump 71 and the influence of work conditions such as wind and ground inclination at the work site. Even in such a case, in the present embodiment, the slewing control unit 802 outputs the auxiliary command signal, so that it is possible to take measures to reduce the slewing angular velocity of the upper slewing body 12. In particular, by inputting the auxiliary command signal to the display unit 85, it is possible to notify and warn the worker of the possibility that the slewing angular velocity will exceed. As a result, the worker greatly reduces the operation amount of the operation lever of the operation unit 81, so that the slewing angular velocity can be reduced. When the crane 10 includes the hydraulic circuit having the neutral free structure as described above, the worker may forcibly apply the hydraulic brake by performing reverse lever operation (operation of opening the control valve to make oil flow in a direction opposite to the original slewing direction). As a result, it is possible to prevent the slewing angular velocity of the upper slewing body 12 from greatly exceeding the slewing angular velocity limit value ωr. Therefore, the safety in the slewing operation of the upper slewing body 12 can be further enhanced.

In particular, upon receiving the warning information displayed on the display unit 85, the worker who operates the operation unit 81 can intuitively recognize that the slewing angular velocity of the upper slewing body 12 approaches the slewing angular velocity limit value ωr with the current operation amount. Therefore, in the subsequent operation, the operation amount of the operation unit 81 is increased or decreased, so that the number of times of the warning display as described above is reduced.

FIG. 13 is a graph showing the change of the slewing angular velocity in the slewing control performed by the slewing control device 8S according to the present embodiment. According to the control of the slewing angular velocity as described above, as shown in FIG. 13, it is possible to stably prevent the actual slewing angular velocity from exceeding the slewing angular velocity limit value ωr.

In the present embodiment, the slewing control unit 802 limits the discharge amount of the hydraulic oil to be discharged from the hydraulic pump 71 such that the slewing angular velocity of the upper slewing body 12 does not exceed the maximum slewing angular velocity by adjusting the tilt of the hydraulic pump 71, making it possible to limit the slewing angular velocity of the upper slewing body 12 using the structure of the hydraulic circuit.

In the present embodiment, the attachment information included in the load information includes a length of the attachment 10S from the proximal end to the distal end of the attachment 10S. The angular velocity setting unit 801 sets the maximum slewing angular velocity to a first slewing angular velocity when the length of the attachment 10S is a first length, and sets the maximum slewing angular velocity to a second slewing angular velocity smaller than the first slewing angular velocity when the length of the attachment 10S is a second length greater than the first length. That is, the angular velocity setting unit 801 sets the maximum slewing angular velocity such that the maximum slewing angular velocity decreases as the length of the attachment 10S increases.

With such a configuration, since the angular velocity setting unit 801 sets the maximum slewing angular velocity of the upper slewing body 12 relatively small when the relatively long attachment 10S is attached to the upper slewing body 12, it is possible to inhibit the attachment 10S from being damaged or broken due to a large transverse load applied to the attachment 10S. In particular, when the attachment 10S with low strength such as a long attachment is attached to the upper slewing body 12, even if the worker suddenly inputs a large slewing operation through the operation lever 81A, since the angular velocity setting unit 801 limits the maximum slewing angular velocity, it is possible to reduce the deformation of the attachment 10S due to the cargo shaking equal to or less than the allowable value, and it is possible to reduce the risk of breakage to the attachment 10S as described above and perform safe operations.

In the present embodiment, the slewing operation information included in the load information includes information corresponding to a hoist cargo load that is a load of a hoist cargo connected to the main winding rope 50, and the angular velocity setting unit 801 sets the maximum slewing angular velocity based on the hoist cargo load acquired by the slewing operation information acquisition unit 800B.

With such a configuration, since the angular velocity setting unit 801 sets the maximum slewing angular velocity based on the hoist cargo load that can have a significant impact on the transverse load acting on the attachment 10S, it is possible to securely inhibit a large transverse load from acting on the attachment 10S.

In particular, the angular velocity setting unit 801 sets the maximum slewing angular velocity to a third slewing angular velocity when the hoist cargo load is a first load (light load), and sets the maximum slewing angular velocity to a fourth slewing angular velocity smaller than the third slewing angular velocity when the hoist cargo load is a second load (heavy load) greater than the first load. That is, the angular velocity setting unit 801 sets the maximum slewing angular velocity such that the maximum slewing angular velocity decreases as the hoist cargo load increases.

With such a configuration, when the hoist cargo with the relatively large load is connected to the attachment 10S, the angular velocity setting unit 801 sets the maximum slewing angular velocity of the upper slewing body 12 relatively small, and therefore it is possible to securely inhibit the attachment 10S from being damaged or broken due to a large transverse load applied to the attachment 10S.

Further, in the present embodiment, in the same attachment information, the angular velocity setting unit 801 preferably sets the maximum slewing angular velocity to one slewing angular velocity (fifth slewing angular velocity) when the working radius R is a first working radius, and sets the maximum slewing angular velocity to another slewing angular velocity (sixth slewing angular velocity) smaller than the one slewing angular velocity when the working radius R is a second working radius that is larger than the first working radius. That is, the angular velocity setting unit 801 may set the maximum slewing angular velocity such that the maximum slewing angular velocity decreases as the working radius R increases.

With such a configuration, since the angular velocity setting unit 801 sets the maximum slewing angular velocity of the upper slewing body 12 relatively small when a relatively large working radius is set for the attachment 10S, it is possible to securely inhibit the attachment 10S from being damaged or broken due to a large transverse load applied to the attachment 10S.

### Modified Embodiment

Next, a modified embodiment based on the first embodiment will be described.

Specifically, after the slewing angular velocity limit value ωr (maximum slewing angular velocity) is set in step S4 of FIG. 11, predetermined determination processing may be executed, and only in a case where the slewing angular velocity limit value ωr is less than the minimum slewing angular velocity ω1 stored in advance in the storage unit 803 (FIG. 3), the processing after step S6 may be executed. This is because when the slewing angular velocity limit value or is equal to or greater than the minimum slewing angular velocity ω1, the slewing angular velocity can be controlled by the tilt control of the hydraulic pump 71.

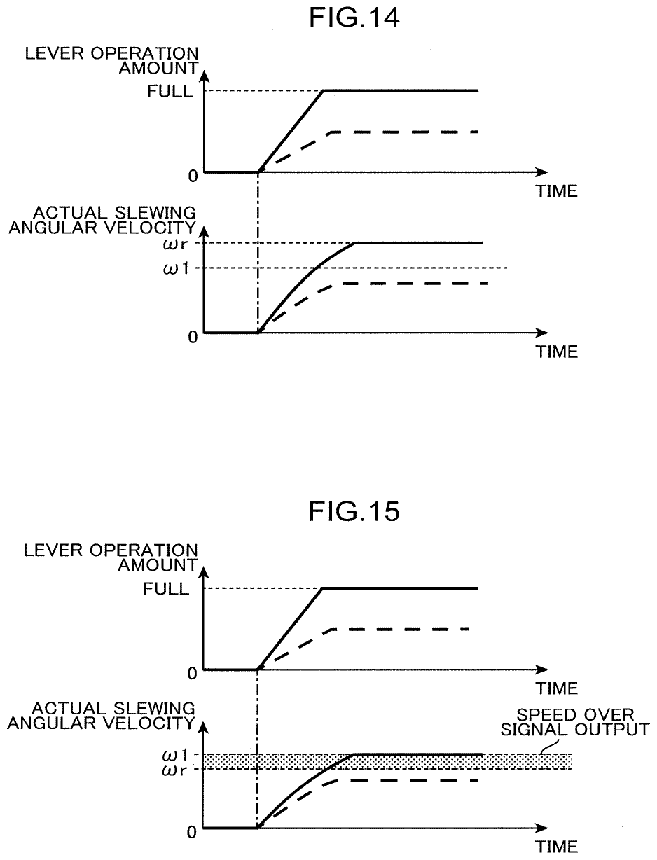

FIGS. 14 and 15 are graphs showing time transition of the lever operation amount and the actual slewing angular velocity in the slewing control executed by the slewing control device 8S according to the present modified embodiment. FIG. 13 corresponds to a case of ωr>ω1, and FIG. 14 corresponds to a case of ωr≤ω1.

For example, the relationship of ωr>ω1 corresponds to a case where the hoist cargo load is small or a case where the working radius is small. In this case, as shown in FIG. 14, when the lever operation amount is operated to the FULL state (solid line), the tilt (pump capacity) of the hydraulic pump 71 is controlled so that the actual slewing angular velocity becomes ωr. As indicated by a broken line in FIG. 14, when the lever operation amount is half, the actual slewing angular velocity is smaller than ωr. Under the condition shown in FIG. 14, even when the lever operation amount is in the FULL state, the maximum slewing angular velocity is controlled to or or less by the above-described slewing control, so that safety can be secured. In the present modified embodiment including the first embodiment described above, the number of engine revolutions can be set to two levels of HIGH and LOW, and FIG. 14 illustrates the HIGH state. If the number of engine revolutions is set to LOW, the slewing angular velocity relatively decreases, so that the slewing angular velocity can be set to ωr or less even when the lever operation amount is FULL.

On the other hand, the relationship of ωr≤ω1 corresponds to, for example, a case where the hoist cargo load is large or a case where the working radius is large. In this case, as shown in FIG. 15, when the lever operation amount is operated to the FULL state, the actual slewing angular velocity is controlled to ω1, but cannot be controlled to the originally target slewing angular velocity limit value ωr or less. Even in such a case, similarly to the first embodiment described above, the actual slewing angular velocity is detected, and when the actual slewing angular velocity exceeds the slewing angular velocity limit value ωr, the auxiliary command signal is output, so that the deceleration operation can be urged to the operator. In this case, the operator can lower the slewing angular velocity of the upper slewing body 12 by lowering the lever operation amount, reducing the engine rotation, or performing the reverse lever operation, and can enhance the safety of the slewing operation. Even in this case, if the operator does not perform the lever operation to the FULL state in the first place, the slewing angular velocity can be set to ωr or less, so that the safety is secured without outputting the auxiliary command signal. The case where the number of engine revolutions is set to LOW is similar to that in FIG. 14.

### Second Embodiment

Next, a crane 10 including a slewing control device 8S according to a second embodiment of the present invention will be described. Note that in the present embodiment, the description will focus on the difference from the previous first embodiment, and the description of common points will be omitted (the same applies to subsequent embodiments).

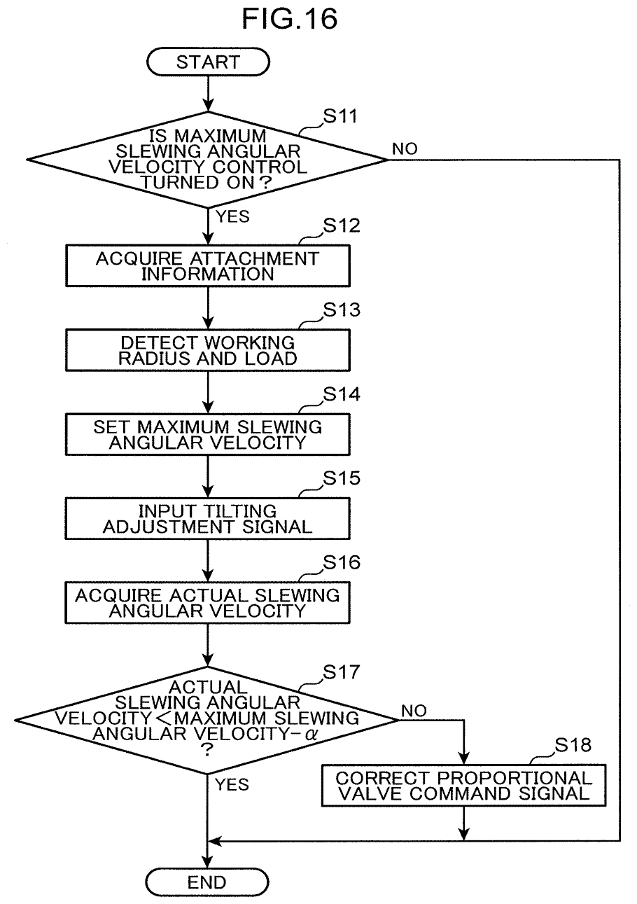

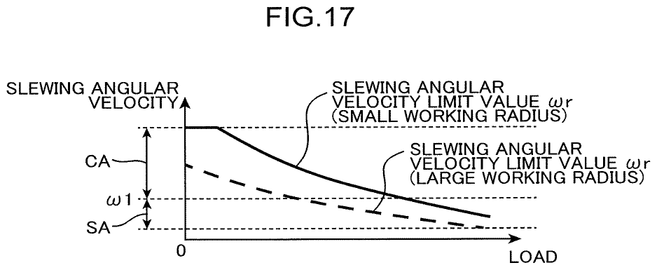

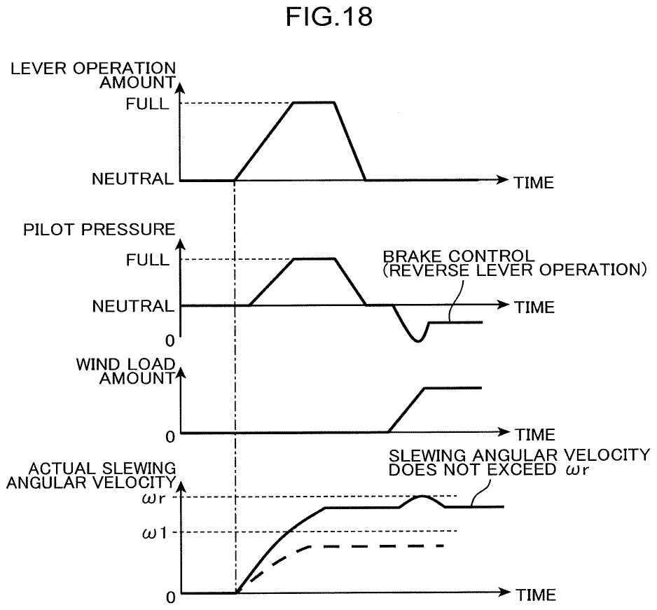

The present embodiment is characterized in that the slewing control device 8S automatically controls the slewing angular velocity of the upper slewing body 12 based on the auxiliary command signal. FIG. 16 is a flowchart of the slewing control of the crane 10 performed by the slewing control device 8S according to the present embodiment. FIG. 17 is a graph showing a control area CA and an auxiliary control area SA in the slewing control of the crane 10 executed by the slewing control device 8S according to the present embodiment. FIG. 18 is a graph showing time transition of the lever operation amount, the pilot pressure, and the actual slewing angular velocity in the slewing control executed by the slewing control device 8S according to the present embodiment.

Steps S11 to S17 in the flowchart of FIG. 16 are similar to steps SI to S7 in FIG. 11. Then, in step S17, when the actual slewing angular velocity is equal to or greater than the maximum slewing angular velocity (NO in step S7), the control unit 80 executes the slewing angular velocity reduction control. Specifically, the slewing control unit 802 of the control unit 80 corrects a proportional valve command signal for the first electromagnetic proportional valve 77 and the second electromagnetic proportional valve 78 (step S18).

In the present embodiment, since the hydraulic circuit of the crane 10 has the above-described neutral free structure, the slewing control unit 802 executes reverse lever control. At this time, the slewing control unit 802 calculates the deviation between the actual slewing angular velocity and the target slewing angular velocity, and when the deviation increases, calculates a reverse lever control amount according to the increase amount of the deviation by, for example, a PID control law. Then, as the pilot pressure for determining the opening degree of the control valve 73, the proportional valve command signal is input to the first electromagnetic proportional valve 77 or the second electromagnetic proportional valve 78 so that the control valve 73 opens in a direction opposite to the current slewing direction. In other words, the slewing control unit 802 forcibly corrects the proportional valve command signal corresponding to the operation input to the operation unit 81 as described above.

As described above, in the present embodiment, the slewing control unit 802 corrects the slewing command signal received from the operation unit 81 so that the slewing angular velocity of the upper slewing body 12 decreases, and inputs the corrected slewing command signal to the slewing drive unit 7S (first electromagnetic proportional valve 77, second electromagnetic proportional valve 78) as an auxiliary command signal.

Even in such control, when the slewing angular velocity of the upper slewing body 12 becomes too large, for example, even if there is an influence of a wind load or the like, the slewing angular velocity is controlled to be equal to or less than the slewing angular velocity limit value ωr, so that safety can be enhanced. As described above, the same effect can be obtained even when the slewing speed is increased due to the downward gradient based on the ground inclination at the work site. As described above, in the present embodiment, the slewing speed of the upper slewing body 12 can be stably controlled to be equal to or less than the maximum slewing angular velocity even under the influence of the characteristics of the hydraulic circuit mounted on the crane 10 and the work conditions at the work site.

In FIG. 17, with the minimum slewing angular velocity ω1 as a reference, in a region where the slewing angular velocity is larger than ω1, the slewing angular velocity of the upper slewing body 12 can be effectively limited by the tilt control of the hydraulic pump 71 (control area CA). On the other hand, in the area where the slewing angular velocity is smaller than ω1, it is difficult to effectively limit the slewing angular velocity of the upper slewing body 12 only by the tilt control of the hydraulic pump 71. Therefore, the slewing angular velocity of the upper slewing body 12 can be similarly limited by the control of the first electromagnetic proportional valve 77 and the second electromagnetic proportional valve 78 based on the auxiliary command signal as described above (auxiliary control area SA).

Further, as shown in FIG. 18, when the lever operation amount input to the operation unit 81 is in the FULL state and the pilot pressure is also in the FULL state, even if the actual slewing angular velocity approaches or due to the action of the wind load, the pilot pressure corresponding to the reverse lever operation is generated, so that the slewing angular velocity of the upper slewing body 12 can be decelerated.

In addition to the above automatic control, when warning information is displayed on the display unit 85, there is a possibility that the operator performs a reverse lever operation in parallel. In this case, the control amount of the pilot pressure may be calculated so as to control the opening degree of the control valve 73 by, for example, high-level selection of the reverse lever operation amount by the operator and the reverse lever control amount by the above control or the sum of both. As a result, when the operator obtains further deceleration in a state where the deceleration control is operated by the control unit 80, the brake operation of the operator can be prioritized over the control of the control unit 80 by high-level selection. In addition, in a case where both the control amounts are combined, the control of the control unit 80 and the brake operation of the operator are combined to perform the deceleration control, so that the deceleration according to the intention of the operator can be performed.

When the hydraulic circuit of the slewing drive unit 7S does not have the neutral free structure as described above, but the flow of the hydraulic oil in the slewing motor 72 is forcibly stopped when the operation lever is disposed at the neutral position (neutral brake structure), the pilot pressure in the current slewing direction may be controlled to be decreased.

### Third Embodiment

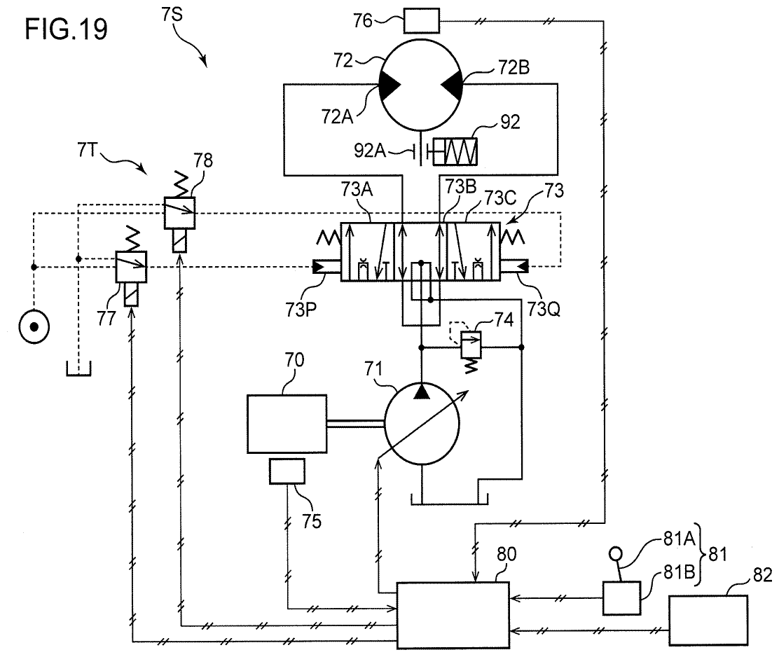

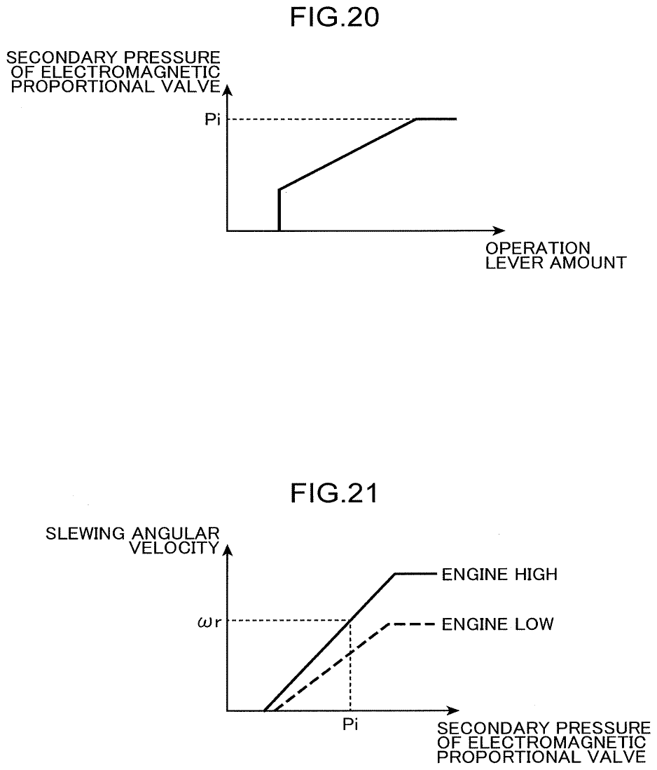

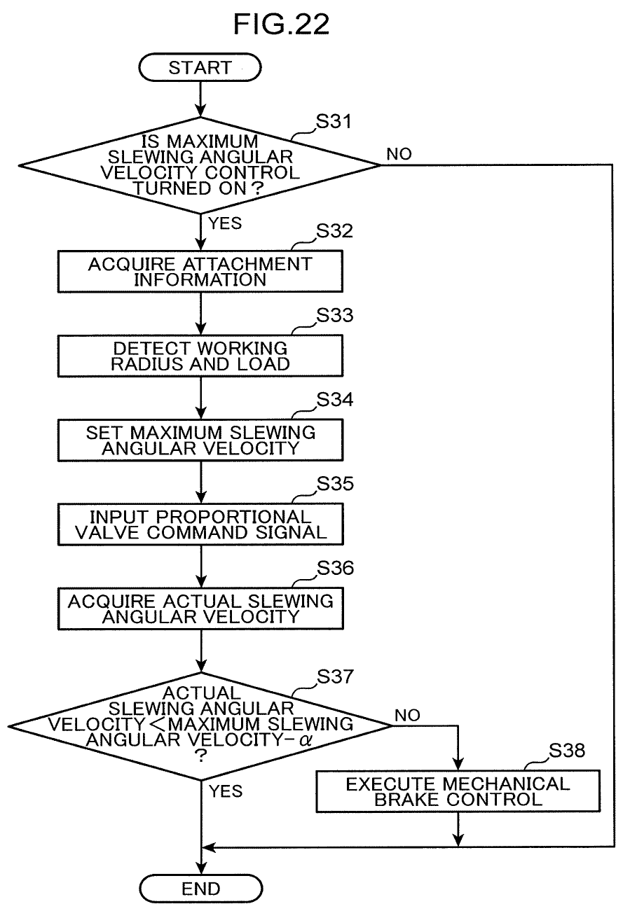

Next, a third embodiment of the present invention will be described. FIG. 19 is a hydraulic circuit diagram of a slewing drive unit 7S of the crane 10 according to the present embodiment. FIG. 20 is a graph showing the relationship between an operation amount of an operation lever and secondary pressure of electromagnetic proportional valves in the slewing control performed by the slewing control device 8S according to the present embodiment. FIG. 21 is a graph showing the relationship between the secondary pressure of the electromagnetic proportional valves and a slewing angular velocity of an upper slewing body 12 in the slewing control performed by the slewing control device 8S according to the present embodiment. FIG. 22 is a flowchart of the slewing control of the crane 10 performed by the slewing control device 8S according to the present embodiment.

Referring to FIG. 19, the present embodiment is different from the first embodiment shown in FIG. 2 in that the slewing drive unit 7S of the crane 10 includes the brake valve 91 and the brake cylinder 92. As described above, the brake valve 91 and the brake cylinder 92 in FIG. 2 are members according to the present embodiment.

The slewing brake valve 91 (FIG. 3) (mechanical brake device) opens in accordance with an auxiliary command signal received from the slewing control unit 802 to adjust the flow rate of hydraulic oil supplied to and discharged from the brake cylinder 92. As a result, the mechanical brake for the slewing motor 72 (FIG. 2) is switched on and off.

The brake cylinder 92 (mechanical brake device) contracts by receiving the supply of the hydraulic oil from the slewing brake valve 91, and extends by receiving the biasing force of the spring member set in advance by discharging the hydraulic oil inside. A brake pressing portion 92A is fixed to a piston rod of the brake cylinder 92. The brake cylinder 92 operates so as to be switchable between a braking state in which the rotation of the slewing motor 72 is forcibly blocked regardless of the switching position of the control valve 73 and a non-braking state in which the rotation of the slewing motor 72 is allowed. When the piston of the brake cylinder 92 extends, the brake pressing portion 92A comes into sliding contact with the output shaft of the slewing motor 72, and forcibly decelerates or stops the rotation of the slewing motor 72. On the other hand, when the piston of the brake cylinder 92 contracts, the brake pressing portion 92A separates from the output shaft of the slewing motor 72 and allows the rotation of the slewing motor 72. The worker can also apply a mechanical braking force by the brake pressing portion 92A of the brake cylinder 92 to the slewing motor 72 by pressing a brake button (not shown) provided in the operation unit 81 (FIG. 3).

In the previous first embodiment, the description has been given in an aspect in which the slewing control unit 802 adjusts the tilt of the hydraulic pump 71 to limit the discharge amount (pump capacity) of the hydraulic oil discharged from the hydraulic pump 71, thereby limiting the slewing angular velocity of the upper slewing body 12. Meanwhile, in the present embodiment, the slewing control unit 802 adjusts the secondary pressure of the first electromagnetic proportional valve 77 and the second electromagnetic proportional valve 78 shown in FIG. 19, and adjusts the flow rate of the hydraulic oil supplied to the slewing motor 72 in the control valve 73, thereby limiting the slewing angular velocity of the upper slewing body 12.

That is, steps S31 to S34 are sequentially executed in the present embodiment as in the previous first embodiment (FIG. 22). Meanwhile, when an angular velocity setting unit 801 sets the maximum slewing angular velocity (slewing angular velocity limit value ωr) in step S34, the slewing control unit 802 inputs a proportional valve command signal (compulsory command signal) to the first electromagnetic proportional valve 77 or the second electromagnetic proportional valve 78 in step S35. Specifically, the slewing control unit 802 limits the secondary pressure of each proportional valve to Pi such that the slewing angular velocity of the upper slewing body 12 does not exceed the slewing angular velocity limit value ωr with respect to the operation amount input to the operation unit 81 (FIG. 20). Since there is a relationship as shown in FIG. 21 between the secondary pressure of each of the first electromagnetic proportional valve 77 and the second electromagnetic proportional valve 78, and the slewing angular velocity of the upper slewing body 12, by setting the maximum value of the secondary pressure of the electromagnetic proportional valve to Pi, the maximum value of the slewing angular velocity of the upper slewing body 12 can be limited to or.

On the other hand, also in the present embodiment, the slewing angular velocity of the upper slewing body 12 controlled as described above may approach or exceed the slewing angular velocity limit value ωr against the operator's will. Therefore, when the actual slewing angular velocity is equal to or greater than (maximum slewing angular velocity−α) (NO in step S37) after steps S36 and S37 in FIG. 22, the control unit 80 executes the slewing angular velocity reduction control. Specifically, the slewing control unit 802 inputs an auxiliary command signal to the brake valve 91 to move the brake cylinder 92, and applies a braking force to slewing of the upper slewing body 12 so as to reduce the slewing angular velocity of the upper slewing body 12 (execution of mechanical brake control, S38).

As a result, similarly to the first and second embodiments described above, it is possible to prevent the slewing angular velocity of the upper slewing body 12 from greatly exceeding the slewing angular velocity limit value ωr. In particular, by using the deceleration control by the mechanical brake, the slewing angular velocity of the upper slewing body 12 can be reliably and quickly decelerated. Therefore, even under the influence of the characteristics of the hydraulic circuit mounted on the crane 10 and the work conditions of the work site, the slewing speed of the upper slewing body 12 can be stably controlled to the maximum slewing angular velocity or less by the brake cylinder 92.

A slewing method for the crane 10 according to the present embodiment includes: acquiring load information which is information for setting a maximum slewing angular velocity that is a maximum value of a slewing angular velocity based on a transverse load which is a load along a tangential direction in a slewing operation of the upper slewing body 12 and which acts on the attachment 10S due to the slewing angular velocity of the upper slewing body 12; setting the maximum slewing angular velocity allowed in the slewing operation of the upper slewing body 12 based on the acquired load information; and controlling the slewing drive unit 7S such that the upper slewing body 12 slews with respect to the lower travelling body 14 in response to the slewing command signal output from the operation unit 81, controlling the slewing drive unit 7S such that the slewing angular velocity of the upper slewing body 12 does not exceed the maximum slewing angular velocity, and outputting an auxiliary command signal for reducing the slewing angular velocity of the upper slewing body 12 when the actual slewing angular velocity of the upper slewing body 12 approaches the maximum slewing angular velocity or exceeds the maximum slewing angular velocity.

According to the present method, even when the slewing angular velocity of the upper slewing body 12 is about to exceed the maximum slewing angular velocity due to the influence of the characteristics of the hydraulic circuit mounted on the crane 10 and the work conditions of the work site, it is possible to take measures to reduce the slewing angular velocity of the upper slewing body 12 by outputting the auxiliary command signal.

The above method may further include operating a warning unit such as the display unit 85 in response to the auxiliary command signal to warn a worker who can operate the operation unit 81 that the actual slewing angular velocity of the upper slewing body 12 approaches the maximum slewing angular velocity or exceeds the maximum slewing angular velocity.

According to the present method, even when the slewing angular velocity of the upper slewing body 12 is about to exceed the maximum slewing angular velocity due to the influence of the characteristics of the hydraulic circuit mounted on the crane 10 and the work conditions of the work site, the slewing speed of the upper slewing body 12 can be stably controlled to be equal to or less than the maximum slewing angular velocity by warning the worker of the information.

The above method may further include correcting the slewing command signal received from the operation unit 81 so that the slewing angular velocity of the upper slewing body 12 decreases, and inputting the corrected slewing command signal to the slewing drive unit 7S as the auxiliary command signal.

According to the present method, the slewing speed of the upper slewing body 12 can be stably controlled to be equal to or less than the maximum slewing angular velocity even under the influence of the characteristics of the hydraulic circuit mounted on the crane 10 and the work conditions at the work site.

The above method may further include applying a braking force to the slewing of the upper slewing body 12 so as to reduce the slewing angular velocity of the upper slewing body 12 by inputting the auxiliary command signal to a mechanical brake device (slewing brake valve 91, brake cylinder 92) provided in the slewing drive unit 7S.

According to the present method, the mechanical brake device can stably control the slewing speed of the upper slewing body 12 to be equal to or less than the maximum slewing angular velocity even under the influence of the characteristics of the hydraulic circuit mounted on the crane 10 and the work conditions at the work site.

Note that the contents included in the description of the crane 10 described above can constitute a part of the slewing method for the crane 10 described above.

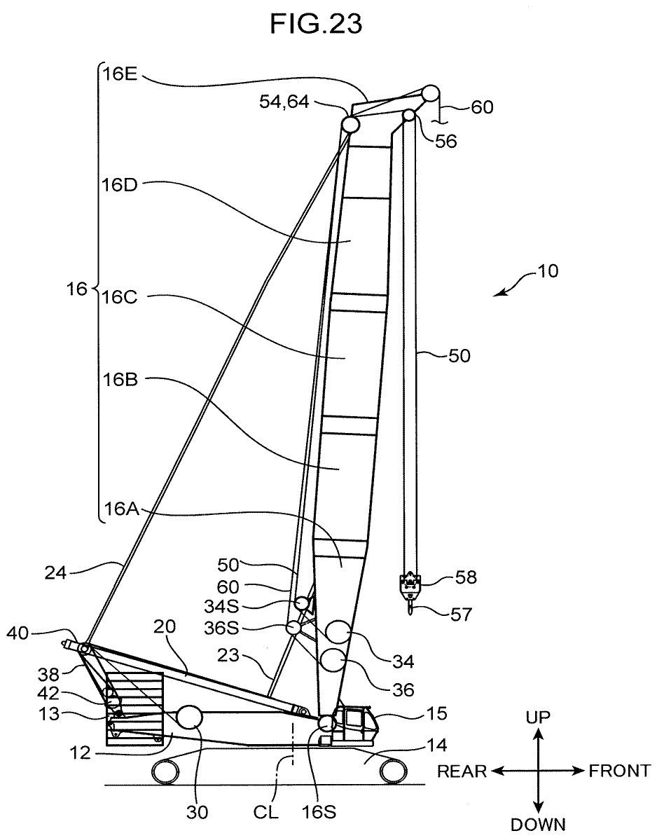

The slewing control device 8S according to respective embodiments of the present invention, the crane 10 including the same, and the slewing method for the crane 10 have been described above. Note that the present invention is not limited to these embodiments. The present invention can adopt the following modified embodiments, for example.
(1) In the above-described embodiments, descriptions have been given using the crane 10 shown in FIG. 1, but the present invention is not limited to this example. FIG. 23 is a side view of a crane 10 including a slewing control device 8S according to the modified embodiment of the present invention. In this modified embodiment, the crane 10 does not include a jib 18 (FIG. 1), and the hoist cargo is hoisted by hanging down a main winding rope 50 (hoist cargo rope) from the distal end of a boom 16 (attachment 10S). In this case, an attachment information acquisition unit 800A only needs to acquire information such as the length of the boom 16 as attachment information, and an angular velocity setting unit 801 only needs to set a slewing angular velocity limit value ωr in the slewing operation of an upper slewing body 12 according to the attachment information. In the previous first embodiment, only the length of the jib 18 of the attachment 10S may be acquired as the attachment information.
(2) The crane 10 shown in FIG. 1 may not include the rear strut 21 and the front strut 22, or may include one strut. The mast structure that supports the boom 16 is also not limited to the structure shown in FIG. 1, and may be another mast structure or a gantry structure (not shown).
(3) In respective embodiments described above, as the attachment information acquired by the attachment information acquisition unit 800A, the description has been given using the length information on the attachment 10S, but the present invention is not limited to this example. The attachment information may include information that is an index of strength against the transverse load, such as stiffness, strength, cross-sectional structure, and material properties of the attachment 10S (boom 16, jib 18, and the like). In this case, when the strength index is large, the angular velocity setting unit 801 may set the slewing angular velocity limit value ωr relatively large. The attachment information may include the years of use of the attachment 10S (elapsed years from date of manufacture), the number of times of attachment and detachment to and from the upper slewing body 12, and the like. The angular velocity setting unit 801 may set the slewing angular velocity limit value ωr relatively small as the number of years and the number of times increase.
(4) The slewing operation information acquired by the slewing operation information acquisition unit 800B is not limited to the hoist cargo load and the working radius (hoisting angle). The slewing operation information may include other information that affects cargo swing of the hoist cargo, swing of the attachment 10S, the transverse load acting on the attachment 10S, stress, and the like, such as wind speed at the work site.
(5) In respective embodiments described above, the description has been given in an aspect in which the slewing angular velocity limit value ωr of the upper slewing body 12 is set based on input of various pieces of information from the input unit 82 and information stored in the storage unit 803 (such as limit value map), but the present invention is not limited to this example. When the unique information and identification information on the attachment 10S are known, the angular velocity setting unit 801 may set the maximum slewing angular velocity (slewing angular velocity limit value ωr) based on the information and an arithmetic expression prepared in advance. At least part of the control unit 80 including the attachment information acquisition unit 800A, the slewing operation information acquisition unit 800B, the angular velocity setting unit 801, and the like may not be mounted on the crane 10 and may be disposed at a distant remote control site. In this case, the slewing angular velocity limit value ωr may be transmitted from the site to the crane 10 (control unit 80) by using a communication device such as wireless. The control unit 80 (attachment information acquisition unit 800A, slewing operation information acquisition unit 800B, angular velocity setting unit 801) and the like may be provided in an operation device (not shown) held by the worker around the crane 10. Furthermore, what is input from the operation unit 81 is the model number (manufacturing number) of the attachment 20S, and the attachment information acquisition unit 800A may acquire length information corresponding to the model number from the storage unit 803.
(6) In addition, the control unit 80 may transmit the information on the slewing angular velocity limit value ωr and the actual slewing angular velocity from the communication unit 86 (FIG. 3) to the remote device together with the specification, the working radius, the hoist cargo load, and the like of the attachment 10S acquired in the slewing control of the upper slewing body 12, and remotely monitor these pieces of information by the IT function of the remote device. In this way, by remotely monitoring the information in the actual work state and grasping how the crane 10 is used at the work site, it is possible to utilize the information as, for example, design information of the crane 10 in the future.
(7) In addition, the storage unit 803 of the control unit 80 may store in advance the relationship information indicating the relationship among the operation amount of the operation received by the operation unit 81, the number of revolutions of the engine 70, and the slewing angular velocity limit value ωr. In this case, in FIG. 21, a map of a mode in which the secondary pressure on the horizontal axis is replaced with the lever operation amount is stored in the storage unit 803. The slewing control unit 802 may derive the slewing angular velocity limit value ωr with reference to the relationship information stored in the storage unit 803 based on the current number of revolutions of the engine 70 and the operation amount, and estimate the slewing angular velocity limit value ωr as the current actual slewing angular velocity. In this case, it is not necessary to directly detect the actual slewing angular velocity of the upper slewing body 12, and the actual slewing angular velocity can be easily estimated.

In particular, as described above, when the number of revolutions of the engine 70 is HIGH, the slewing angular velocity of the upper slewing body 12 is controlled to be the slewing angular velocity limit value ωr in accordance with the state in which the lever operation amount is FULL. Therefore, the slewing angular velocity limit value ωr may be replaced with the actual slewing angular velocity at the time of estimating the actual slewing angular velocity.

The present invention provides a slewing control device used for a crane including: a lower body; an upper slewing body supported by the lower body to be slewable with respect to the lower body; an operation unit that receives an operation to slew the upper slewing body and outputs a slewing command signal according to a magnitude of the operation; a slewing drive unit capable of slewing the upper slewing body with respect to the lower body; an attachment that includes a proximal end pivotably supported by the upper slewing body in a hoisting direction and a distal end opposite the proximal end; and a hoist cargo rope that hangs down from the distal end of the attachment and is connected to a hoist cargo. The slewing control device includes: a load information acquisition unit that acquires load information, the load information being information for setting a maximum slewing angular velocity that is a maximum value of a slewing angular velocity based on a transverse load which is a load along a tangential direction in a slewing operation of the upper slewing body and which acts on the attachment due to a slewing angular velocity of the upper slewing body; an angular velocity setting unit that sets the maximum slewing angular velocity allowed in the slewing operation of the upper slewing body based on the load information acquired by the load information acquisition unit; and a slewing control unit that receives the slewing command signal output from the operation unit, controls the slewing drive unit such that the upper slewing body slews with respect to the lower body in response to the slewing command signal, controls the slewing drive unit so that the slewing angular velocity of the upper slewing body does not exceed the maximum slewing angular velocity set by the angular velocity setting unit, and outputs an auxiliary command signal for reducing the slewing angular velocity of the upper slewing body when an actual slewing angular velocity of the upper slewing body approaches the maximum slewing angular velocity or exceeds the maximum slewing angular velocity.

According to this configuration, even when the slewing angular velocity of the upper slewing body is about to exceed the maximum slewing angular velocity due to the influence of the characteristics of the hydraulic circuit mounted on the crane and the work conditions of the work site, it is possible to take measures to reduce the slewing angular velocity of the upper slewing body by the slewing control unit outputting the auxiliary command signal.

In the above configuration, the crane slewing control device may further include a warning unit that warns a worker who is able to operate the operation unit that the actual slewing angular velocity of the upper slewing body approaches the maximum slewing angular velocity or exceeds the maximum slewing angular velocity in response to the auxiliary command signal output from the slewing control unit.

According to this configuration, even when the slewing angular velocity of the upper slewing body is about to exceed the maximum slewing angular velocity due to the influence of the characteristics of the hydraulic circuit mounted on the crane and the work conditions of the work site, the slewing speed of the upper slewing body can be stably controlled to be equal to or less than the maximum slewing angular velocity by warning the worker of the information.

In the above configuration, the slewing control unit may correct the slewing command signal received from the operation unit so that the slewing angular velocity of the upper slewing body decreases, and input the corrected slewing command signal to the slewing drive unit as the auxiliary command signal.

According to this configuration, the slewing speed of the upper slewing body can be stably controlled to be equal to or less than the maximum slewing angular velocity even under the influence of the characteristics of the hydraulic circuit mounted on the crane and the work conditions at the work site.

In the above configuration, the slewing control unit may apply a braking force to slewing of the upper slewing body so as to reduce the slewing angular velocity of the upper slewing body by inputting the auxiliary command signal to a mechanical brake device provided in the slewing drive unit.

According to this configuration, the mechanical brake device can stably control the slewing speed of the upper slewing body to be equal to or less than the maximum slewing angular velocity even under the influence of the characteristics of the hydraulic circuit mounted on the crane and the work conditions at the work site.

In the above configuration, the crane slewing control device may further include a slewing angle detection unit capable of detecting a slewing angle of the upper slewing body with respect to the lower body, in which the slewing control unit may calculate the actual slewing angular velocity of the upper slewing body from a difference between two slewing angles detected by the slewing angle detection unit at each of a first time and a second time and a time interval between the first time and the second time.

According to this configuration, it is not necessary to mount a device that directly detects the slewing angular velocity, and the slewing angular velocity can be detected using the slewing angle detection unit.

In the above configuration, the slewing control unit may further include a real-time measurement unit capable of setting the first time and the second time based on a system time, and measuring the time interval between the first time and the second time independently of the system time.

According to this configuration, the accuracy of the calculated value of the slewing angular velocity can be improved by using the real-time measured value as the time interval instead of the time interval based on the system time.

In the above configuration, the crane slewing control device may further include a transmission unit capable of transmitting the load information acquired by the load information acquisition unit and the maximum slewing angular velocity set by the angular velocity setting unit in association with each other, and a remote device that is disposed at a position away from the crane and receives and manages the load information and the maximum slewing angular velocity transmitted by the transmission unit.

According to this configuration, by remotely monitoring the information in the actual work state and grasping how the crane is used at the work site, it is possible to utilize the information as, for example, design information in the future.

In the above configuration, the slewing drive unit may include an engine including an output shaft, a hydraulic pump that is coupled to the output shaft and discharges hydraulic oil by power input from the output shaft, and a hydraulic slewing motor that generates a driving force to slew the upper slewing body by receiving hydraulic oil supplied from the hydraulic pump, the crane slewing control device may further include a storage unit that stores in advance relationship information indicating a relationship among an operation amount of an operation received by the operation unit, a number of revolutions of the engine, and the maximum slewing angular velocity, and the slewing control unit may derive the maximum slewing angular velocity with reference to the relationship information stored in the storage unit based on a current number of revolutions of the engine and the operation amount, and estimate the maximum slewing angular velocity as the actual slewing angular velocity.

According to this configuration, it is not necessary to directly detect the actual slewing angular velocity of the upper slewing body, and the actual slewing angular velocity can be easily estimated.

In the above configuration, the slewing drive unit may include: an engine including an output shaft; a variable displacement type hydraulic pump that is coupled to the output shaft and discharges hydraulic oil by power input from the output shaft, the hydraulic pump capable of receiving input of a tilt command signal and change a maximum discharge amount of hydraulic oil according to a magnitude of the tilt command signal; a hydraulic slewing motor that generates a driving force to slew the upper slewing body by receiving hydraulic oil supplied from the hydraulic pump; and a flow rate adjustment mechanism that includes a control valve interposed between the hydraulic pump and the slewing motor, and adjusts a flow rate of hydraulic oil supplied to the slewing motor out of hydraulic oil discharged from the hydraulic pump in response to a command received from the slewing control unit, and the slewing control unit may limit a discharge amount of the hydraulic oil discharged from the hydraulic pump such that the slewing angular velocity of the upper slewing body does not exceed the maximum slewing angular velocity by inputting a tilt command signal corresponding to the maximum slewing angular velocity set by the angular velocity setting unit into the hydraulic pump.

In the above configuration, the slewing drive unit of the crane may include: an engine including an output shaft; a hydraulic pump that is coupled to the output shaft and discharges hydraulic oil by power input from the output shaft; a hydraulic slewing motor that generates a driving force to slew the upper slewing body by receiving hydraulic oil supplied from the hydraulic pump; and a flow rate adjustment mechanism that includes a control valve interposed between the hydraulic pump and the slewing motor and adjusts a flow rate of hydraulic oil supplied to the slewing motor out of hydraulic oil discharged from the hydraulic pump in response to a command received from the slewing control unit, and by inputting a compulsory command signal corresponding to the maximum slewing angular velocity set by the angular velocity setting unit into the flow rate adjustment mechanism, the slewing control unit limits a flow rate of hydraulic oil supplied from the flow rate adjustment mechanism to the slewing motor such that the slewing angular velocity of the upper slewing body does not exceed the maximum slewing angular velocity regardless of a magnitude of the slewing command signal.

A crane provided in the present invention includes: a lower body; an upper slewing body supported by the lower body to be slewable with respect to the lower body; an operation unit that receives an operation to slew the upper slewing body and outputs a slewing command signal according to a magnitude of the operation; a slewing drive unit capable of slewing the upper slewing body with respect to the lower body; an attachment that includes a proximal end pivotably supported by the upper slewing body in a hoisting direction and a distal end opposite the proximal end; a hoist cargo rope that hangs down from the distal end of the attachment and is connected to a hoist cargo; and the crane slewing control device which controls the slewing drive unit so that a slewing angular velocity of the upper slewing body does not exceed a maximum slewing angular velocity.

A slewing method for a crane provided in the present invention is a slewing method for a crane including: a lower body; an upper slewing body supported by the lower body to be slewable with respect to the lower body; an operation unit that receives an operation to slew the upper slewing body and outputs a slewing command signal according to a magnitude of the operation; a slewing drive unit capable of slewing the upper slewing body with respect to the lower body; an attachment that includes a proximal end pivotably supported by the upper slewing body in a hoisting direction and a distal end opposite the proximal end; and a hoist cargo rope that hangs down from the distal end of the attachment and is connected to a hoist cargo. The slewing method includes: acquiring load information which is information for setting a maximum slewing angular velocity that is a maximum value of a slewing angular velocity based on a transverse load which is a load along a tangential direction in a slewing operation of the upper slewing body and which acts on the attachment due to the slewing angular velocity of the upper slewing body; setting the maximum slewing angular velocity allowed in the slewing operation of the upper slewing body based on the acquired load information; controlling the slewing drive unit such that the upper slewing body slews with respect to the lower body in response to the slewing command signal output from the operation unit, controlling the slewing drive unit such that the slewing angular velocity of the upper slewing body does not exceed the maximum slewing angular velocity, and outputting an auxiliary command signal for reducing the slewing angular velocity of the upper slewing body when an actual slewing angular velocity of the upper slewing body approaches the maximum slewing angular velocity or exceeds the maximum slewing angular velocity.

According to the present method, even when the slewing angular velocity of the upper slewing body is about to exceed the maximum slewing angular velocity due to the influence of the characteristics of the hydraulic circuit mounted on the crane and the work conditions of the work site, it is possible to take measures to reduce the slewing angular velocity of the upper slewing body by outputting the auxiliary command signal.

The above method may further include operating a warning unit in response to the auxiliary command signal to warn a worker who is able to operate the operation unit that the actual slewing angular velocity of the upper slewing body approaches the maximum slewing angular velocity or exceeds the maximum slewing angular velocity.

According to the present method, even when the slewing angular velocity of the upper slewing body is about to exceed the maximum slewing angular velocity due to the influence of the characteristics of the hydraulic circuit mounted on the crane and the work conditions of the work site, the slewing speed of the upper slewing body can be stably controlled to be equal to or less than the maximum slewing angular velocity by warning the worker of the information.

The above method may further include correcting the slewing command signal received from the operation unit so that the slewing angular velocity of the upper slewing body decreases, and inputting the corrected slewing command signal to the slewing drive unit as the auxiliary command signal.

According to the present method, the slewing speed of the upper slewing body can be stably controlled to be equal to or less than the maximum slewing angular velocity even under the influence of the characteristics of the hydraulic circuit mounted on the crane and the work conditions at the work site.

The above method may further include applying a braking force to slewing of the upper slewing body so as to reduce the slewing angular velocity of the upper slewing body by inputting the auxiliary command signal to a mechanical brake device provided in the slewing drive unit.

According to the present method, the mechanical brake device can stably control the slewing speed of the upper slewing body to be equal to or less than the maximum slewing angular velocity even under the influence of the characteristics of the hydraulic circuit mounted on the crane and the work conditions at the work site.

According to the present invention, there are provided a crane slewing control device capable of stably suppressing damage and breakage of an attachment by application of a large transverse load to the attachment by a slewing operation of an upper slewing body, a crane including the crane slewing control device, and a slewing method for a crane.

1. A crane slewing control device used for a crane including:
a lower body;
an upper slewing body supported by the lower body to be slewable with respect to the lower body;
an operation unit that receives an operation to slew the upper slewing body and outputs a slewing command signal according to a magnitude of the operation;
a slewing drive unit capable of slewing the upper slewing body with respect to the lower body;
an attachment that includes a proximal end pivotably supported by the upper slewing body in a hoisting direction and a distal end opposite the proximal end; and
a hoist cargo rope that hangs down from the distal end of the attachment and is connected to a hoist cargo,
the crane slewing control device comprising:
a load information acquisition unit that acquires load information, the load information being information for setting a maximum slewing angular velocity that is a maximum value of a slewing angular velocity based on a transverse load which is a load along a tangential direction in a slewing operation of the upper slewing body and which acts on the attachment due to a slewing angular velocity of the upper slewing body;
an angular velocity setting unit that sets the maximum slewing angular velocity allowed in the slewing operation of the upper slewing body based on the load information acquired by the load information acquisition unit; and
a slewing control unit that receives the slewing command signal output from the operation unit, controls the slewing drive unit such that the upper slewing body slews with respect to the lower body in response to the slewing command signal, controls the slewing drive unit so that the slewing angular velocity of the upper slewing body does not exceed the maximum slewing angular velocity set by the angular velocity setting unit, and outputs an auxiliary command signal for reducing the slewing angular velocity of the upper slewing body when an actual slewing angular velocity of the upper slewing body approaches the maximum slewing angular velocity or exceeds the maximum slewing angular velocity.

2. The crane slewing control device according to claim 1, further comprising a warning unit that warns a worker who is able to operate the operation unit that the actual slewing angular velocity of the upper slewing body approaches the maximum slewing angular velocity or exceeds the maximum slewing angular velocity in response to the auxiliary command signal output from the slewing control unit.

3. The crane slewing control device according to claim 1, wherein the slewing control unit corrects the slewing command signal received from the operation unit so that the slewing angular velocity of the upper slewing body decreases, and inputs the corrected slewing command signal to the slewing drive unit as the auxiliary command signal.

4. The crane slewing control device according to claim 1, wherein the slewing control unit applies a braking force to slewing of the upper slewing body so as to reduce the slewing angular velocity of the upper slewing body by inputting the auxiliary command signal to a mechanical brake device provided in the slewing drive unit.

5. The crane slewing control device according to claim 1, further comprising a slewing angle detection unit capable of detecting a slewing angle of the upper slewing body with respect to the lower body,
wherein the slewing control unit calculates the actual slewing angular velocity of the upper slewing body from a difference between two slewing angles detected by the slewing angle detection unit at each of a first time and a second time and a time interval between the first time and the second time.

6. The crane slewing control device according to claim 5, wherein
the slewing control unit further includes a real-time measurement unit capable of
setting the first time and the second time based on a system time, and
measuring the time interval between the first time and the second time independently of the system time.

7. The crane slewing control device according to claim 1, further comprising:
a transmission unit capable of transmitting the load information acquired by the load information acquisition unit and the maximum slewing angular velocity set by the angular velocity setting unit in association with each other; and
a remote device that is disposed at a position away from the crane and receives and manages the load information and the maximum slewing angular velocity transmitted by the transmission unit.

8. The crane slewing control device according to claim 1, wherein
the slewing drive unit includes:
an engine including an output shaft;
a hydraulic pump that is coupled to the output shaft and discharges hydraulic oil by power input from the output shaft; and
a hydraulic slewing motor that generates a driving force to slew the upper slewing body by receiving hydraulic oil supplied from the hydraulic pump,
the crane slewing control device further comprises a storage unit that stores in advance relationship information indicating a relationship among an operation amount of an operation received by the operation unit, a number of revolutions of the engine, and the maximum slewing angular velocity, and
the slewing control unit derives the maximum slewing angular velocity with reference to the relationship information stored in the storage unit based on a current number of revolutions of the engine and the operation amount, and estimates the maximum slewing angular velocity as the actual slewing angular velocity.

9. The crane slewing control device according to claim 1, wherein
the slewing drive unit includes:
an engine including an output shaft;
a variable displacement type hydraulic pump that is coupled to the output shaft and discharges hydraulic oil by power input from the output shaft, the hydraulic pump capable of receiving input of a tilt command signal and change a maximum discharge amount of hydraulic oil according to a magnitude of the tilt command signal;
a hydraulic slewing motor that generates a driving force to slew the upper slewing body by receiving hydraulic oil supplied from the hydraulic pump; and
a flow rate adjustment mechanism that includes a control valve interposed between the hydraulic pump and the slewing motor, and adjusts a flow rate of hydraulic oil supplied to the slewing motor out of hydraulic oil discharged from the hydraulic pump in response to a command received from the slewing control unit, and
the slewing control unit limits a discharge amount of hydraulic oil discharged from the hydraulic pump such that the slewing angular velocity of the upper slewing body does not exceed the maximum slewing angular velocity by inputting a tilt command signal corresponding to the maximum slewing angular velocity set by the angular velocity setting unit into the hydraulic pump.

10. The crane slewing control device according to claim 1, wherein
the slewing drive unit of the crane includes:
an engine including an output shaft;
a hydraulic pump that is coupled to the output shaft and discharges hydraulic oil by power input from the output shaft;
a hydraulic slewing motor that generates a driving force to slew the upper slewing body by receiving hydraulic oil supplied from the hydraulic pump; and
a flow rate adjustment mechanism that includes a control valve interposed between the hydraulic pump and the slewing motor and adjusts a flow rate of hydraulic oil supplied to the slewing motor out of hydraulic oil discharged from the hydraulic pump in response to a command received from the slewing control unit, and
by inputting a compulsory command signal corresponding to the maximum slewing angular velocity set by the angular velocity setting unit into the flow rate adjustment mechanism, the slewing control unit limits a flow rate of hydraulic oil supplied from the flow rate adjustment mechanism to the slewing motor such that the slewing angular velocity of the upper slewing body does not exceed the maximum slewing angular velocity regardless of a magnitude of the slewing command signal.

11. A crane comprising:
a lower body;
an upper slewing body supported by the lower body to be slewable with respect to the lower body;
an operation unit that receives an operation to slew the upper slewing body and outputs a slewing command signal according to a magnitude of the operation;
a slewing drive unit capable of slewing the upper slewing body with respect to the lower body;
an attachment that includes a proximal end pivotably supported by the upper slewing body in a hoisting direction and a distal end opposite the proximal end;
a hoist cargo rope that hangs down from the distal end of the attachment and is connected to a hoist cargo; and
the crane slewing control device according to claim 1 which controls the slewing drive unit so that the slewing angular velocity of the upper slewing body does not exceed the maximum slewing angular velocity.

12. A slewing method for a crane including: a lower body; an upper slewing body supported by the lower body to be slewable with respect to the lower body; an operation unit that receives an operation to slew the upper slewing body and outputs a slewing command signal according to a magnitude of the operation; a slewing drive unit capable of slewing the upper slewing body with respect to the lower body; an attachment that includes a proximal end pivotably supported by the upper slewing body in a hoisting direction and a distal end opposite the proximal end; and a hoist cargo rope that hangs down from the distal end of the attachment and is connected to a hoist cargo,
the slewing method comprising:
acquiring load information which is information for setting a maximum slewing angular velocity that is a maximum value of a slewing angular velocity based on a transverse load which is a load along a tangential direction in a slewing operation of the upper slewing body and which acts on the attachment due to the slewing angular velocity of the upper slewing body;
setting the maximum slewing angular velocity allowed in the slewing operation of the upper slewing body based on the acquired load information;
controlling the slewing drive unit such that the upper slewing body slews with respect to the lower body in response to the slewing command signal output from the operation unit, controlling the slewing drive unit such that the slewing angular velocity of the upper slewing body does not exceed the maximum slewing angular velocity, and outputting an auxiliary command signal for reducing the slewing angular velocity of the upper slewing body when an actual slewing angular velocity of the upper slewing body approaches the maximum slewing angular velocity or exceeds the maximum slewing angular velocity.

13. The slewing method for a crane according to claim 12, further comprising operating a warning unit in response to the auxiliary command signal to warn a worker who is able to operate the operation unit that the actual slewing angular velocity of the upper slewing body approaches the maximum slewing angular velocity or exceeds the maximum slewing angular velocity.

14. The slewing method for a crane according to claim 12, further comprising correcting the slewing command signal received from the operation unit so that the slewing angular velocity of the upper slewing body decreases, and inputting the corrected slewing command signal to the slewing drive unit as the auxiliary command signal.

15. The slewing method for a crane according to claim 12, further comprising applying a braking force to slewing of the upper slewing body so as to reduce the slewing angular velocity of the upper slewing body by inputting the auxiliary command signal to a mechanical brake device provided in the slewing drive unit.
